(19) United States
(12) Patent Application Publication
(10) Pub. No.: US 2023/0418373 A1
(43) Pub. Date: Dec. 28, 2023

(54) VIDEO PROCESSING SYSTEMS, COMPUTING SYSTEMS AND METHODS

(71) Applicant: Tobii AB, Danderyd (SE)

(72) Inventors: Erland GEORGE-SVAHN, Stockholm (SE); David HENDEREK, Enskede (SE); Dimitrios KOUFOS, Bagarmossen (SE); Deepak AKKIL, Täby (SE)

(21) Appl. No.: 18/252,878

(22) PCT Filed: Nov. 12, 2021
(86) PCT No.: PCT/EP2021/081599

§ 371 Date: May 13, 2023

Related U.S. Application Data
(60) Provisional application No. 63/113,392, filed on Nov. 13, 2020.

(51) Int. Cl. G06F 3/01; G06F 3/04812; G06F 3/04817

(52) U.S. Cl. CPC G06F 3/013; G06F 2203/011; G06F 3/04817; G06F 3/04812

(57) ABSTRACT

A controller (442) for a video processing system (400). The controller (442) is configured to receive acquired images; recognise a looking-stimulus by determining that an acquired image shows a user to be looking towards the camera or a display screen; and/or recognise a present-stimulus by determining that a user is visible in an acquired image an acquired image shows a user that is not looking towards the camera or the display screen. The controller (442) can then generate a video stream based on the acquired images, and set a characteristic of the video stream based on the recognised looking-stimulus or the present-stimulus.

### TECHNICAL FIELD

The present invention relates to video processing systems such as video conferencing systems and video broadcasting/streaming systems, computing systems and methods that generally, although not necessarily, process images of a user of the system to identify a stimulus for taking further action.

### BACKGROUND

As more and more people worldwide begin to work remotely, new problems associated with remote work and video calling are starting to emerge in terms of privacy, wellbeing and bandwidth issues. Such issues may pertain to the protection of the privacy of the user of a video conferencing system, other people in the surroundings of the user, or simply to ensuring that bandwidth is used as efficiently as possible to prevent slow-down of services. It is therefore desirable to optimise video conferencing systems in view of these and other issues.

### SUMMARY

According to a first aspect of the present disclosure, there is provided a controller for a video processing system, wherein the controller is configured to:
receive acquired images;
recognise a looking-stimulus by determining that an acquired image shows a user to be looking towards the camera or a display screen; and/or
recognise a present-stimulus by determining that a user is present/visible in an acquired image; and
generate a video stream based on the acquired images, and set a characteristic of the video stream based on the recognised looking-stimulus and/or the present-stimulus.

Advantageously, such a controller can improve the social interaction with the video stream.

The controller may be configured to set the characteristic of the video stream based on the recognised looking-stimulus or present-stimulus by modifying the acquired images to generate the video stream.

The video stream may comprise status data. The controller may be configured to set the characteristic of the video stream based on the recognised looking-stimulus or present-stimulus by setting the status data.

The controller may be configured to:
recognise a not-looking-stimulus by determining that an acquired image shows a user that is not looking towards the camera or the display screen; and/or
recognise an absent-stimulus by determining that a user is not present in an acquired image; and
set a characteristic of the video stream based on the recognised not-looking-stimulus and/or the absent-stimulus.

The controller may be further configured to:
set the characteristic of the video stream based on the recognised looking-stimulus or present-stimulus by applying a predetermined operation to the acquired images.

Following recognition of an absent-stimulus, the controller may be configured to:
recognise a present-stimulus by determining that a predetermined user is visible in an acquired image; and
generate the video stream and unset the characteristic of the video stream that was set in response to recognising the absent-stimulus.

The controller may be configured to:
determine the identity of a user in an acquired image before the recognition of the absent-stimulus; and
recognise the present-stimulus by determining that the identified user is present/visible in an acquired image.

According to a further aspect of the present disclosure, there is provided a computer-implemented method of operating a video processing system, the method comprising:
receiving acquired images;
recognising a looking-stimulus by determining that an acquired image shows a user to be looking towards the camera or a display screen; and/or
recognising a present-stimulus by determining that a user is present in an acquired image; and
generating a video stream based on the acquired images, and setting a characteristic of the video stream based on the recognised looking-stimulus or the present-stimulus.

According to a further aspect of the present disclosure, there is provided a controller for a video processing system, wherein the controller is configured to:
receive acquired images;
recognise an absent-stimulus by determining that a user is not visible in an acquired image; and
generate a video stream based on the acquired images, and set a characteristic of the video stream based on the absent-stimulus by automatically creating, and providing as the video stream, a looping video of historic video stream data during which the absent-stimulus was not recognised.

The controller may be configured to:
process historic video stream data and identify clips of the historic video stream that do not contain any predetermined types of stimuli; and
provide the outgoing video stream based on the identified clips of the historic video stream.

According to a further aspect of the present disclosure, there is provided a computer-implemented method of operating a video processing system, the method comprising:
receiving acquired images;
recognising an absent-stimulus by determining that a user is not visible in an acquired image; and
generating a video stream based on the acquired images, and setting a characteristic of the video stream based on the absent-stimulus by automatically creating, and providing as the video stream, a looping video of historic video stream data during which the absent-stimulus was not recognised.

According to a further aspect of the present disclosure, there is provided a controller for a video processing system, wherein the controller is configured to:
receive acquired images;
recognise an emotional-stimulus in one or more of the acquired images; and
generate a video stream based on the acquired images, and set a characteristic of the video stream based on the recognised emotional-stimulus.

The controller may be configured to set the characteristic of the video stream based on the recognised emotional-stimulus by:
modifying the acquired images such that they include a visual representation of the recognised emotional-stimulus; or
setting meta-data of the video stream based on the recognised emotional-stimulus.

The emotional-stimulus may comprises one or more of: a smiling-stimulus, a happy-stimulus, a frowning-stimulus, a sad-stimulus, an angry-stimulus, a crying-stimulus, a disgusted-stimulus, a fearful-stimulus, a surprised¬-stimulus, a neutral-stimulus, a winking-stimulus, a blinking-stimulus, a raising-eye-brows-stimulus, an opening-mouth-to-show-surprise-stimulus, an opening-mouth-to-show-awe-stimulus, and a frowning-stimulus.

According to a further aspect of the present disclosure, there is provided a controller for a video processing system, wherein the controller is configured to:
receive acquired images;
recognise a gesture-stimulus in one or more of the acquired images; and
generate a video stream based on the acquired images, and set a characteristic of the video stream based on the recognised gesture-stimulus.

The controller may be configured to set the characteristic of the video stream based on the recognised gesture-stimulus by:
modifying the acquired images such that they include a visual representation of the recognised gesture-stimulus; or
setting meta-data of the video stream based on the recognised gesture-stimulus.

The gesture-stimulus may comprise one or more of a thumbs-up, a thumbs-down, a wave, clapping, and raising a hand.

According to a further aspect of the present disclosure, there is provided a controller for a video processing system, wherein the video processing system includes:
a camera for acquiring images;
a display screen for displaying visual content to the user; and
an eye tracking system for identifying a user's eyes in the acquired images and providing a gaze-signal that represents the direction of the user's gaze;
   wherein the controller is configured to:
recognise a read-status-stimulus in one or more images based on the received gaze-signal; and
generate a video stream based on the acquired images, and set a characteristic of the video stream based on the recognised read-status-stimulus.

The controller may be configured to recognise the read-status-stimulus by recognising a pattern in the gaze-signal that is associated with eye movement as a user is reading.

The video stream may comprise status data. The controller may be configured to set the characteristic of the video stream based on the recognised read-status-stimulus by setting the status data.

The controller may be configured to: recognise the read-status-stimulus in one or more images based on: the received gaze-signal; and a text-signal that represents text that is displayed to the user. The text-signal may represents: a location on the display screen that text is displayed to the user; the quantity of text that is displayed to the user; the content of the text that is displayed to the user.

The controller may be configured to recognise the read-status-stimulus if the received gaze-signal is: i) indicative of the user reading; and ii) the gaze-signal indicates that the user is looking at a region of the display screen that includes text, as defined by the text-signal.

According to a further aspect of the present disclosure, there is provided a computer-implemented method of operating a video processing system, the method comprising:
recognising a read-status-stimulus in one or more acquired images based on a received gaze-signal; and
generating a video stream based on the acquired images, and setting a characteristic of the video stream based on the recognised read-status-stimulus.

According to a further aspect of the present disclosure, there is provided a controller for a video conferencing system, wherein the video conferencing system includes:
a camera for acquiring images;
an eye tracking system for identifying a user's eyes in the acquired images and providing a gaze-signal that represents the direction of the user's gaze;
a display screen for displaying visual content to the user;
a transmission system for transmitting a video stream to a receiving computer;
   the controller configured to:
determine a region of the display screen that the user is looking at based on the gaze-signal;
determine an identifier of visual content that is being displayed in the region of the display screen that the user is looking at; and
if the determined identifier represents an incoming video stream from a remote user that includes an image of the remote user, then:
   generate the video stream based on the acquired images by modifying the representation of the user's eyes in the video stream such that they are looking in a different direction to the user's eyes in the corresponding acquired images.

The controller may be configured to:
determine an offset between the direction of the user's gaze as defined by the gaze-signal and a line of sight between the user's eyes and the camera; and
based on the determined offset, modify the representation of the user's eyes in the video stream such that they are looking in a different direction to the user's eyes in the corresponding acquired images.

The controller may be configured to:
apply the determined offset to the direction of the user's gaze as defined by the gaze-signal in order to determine a corrected-gaze-direction; and
generate the representation of the user's eyes such that they appear to be looking in the corrected-gaze-direction.

The controller may be further configured to:
if the determined identifier does not represent an incoming video stream from a remote user that includes an image of the remote user, then:
   generate the video stream based on the acquired images such that the representation of the user's eyes in the video stream are looking in the same direction as the user's eyes in the corresponding acquired images.

The controller may be configured to:
generate the video stream by replacing the user that is recognised in the acquired images with an avatar;
if the determined identifier represents an incoming video stream from a remote user that includes an image of the remote user, then:
   generate the video stream based on the acquired images such that the avatar's eyes in the video stream are looking in a different direction to the user's eyes in the corresponding acquired images; and
if the determined identifier does not represent an incoming video stream from a remote user, then generate the video stream based on the acquired images such that the avatar's eyes in the video stream are looking in the same direction as the user's eyes in the corresponding acquired images.

According to a further aspect of the present disclosure, there is provided a computer-implemented method of operating a video conferencing system, the method comprising:
determining a region of a display screen that the user is looking at based on a received gaze-signal;
determining an identifier of visual content that is being displayed in the region of the display screen that the user is looking at; and
if the determined identifier represents an incoming video stream from a remote user that includes an image of the remote user, then:
   generating a video stream based on the acquired images by modifying the representation of the user's eyes in the video stream such that they are looking in a different direction to the user's eyes in the corresponding acquired images

According to a further aspect of the present disclosure, there is provided a controller for a video conferencing system, wherein the video conferencing system includes:
a camera for acquiring images;
an eye tracking system for identifying a user's eyes in the acquired images and providing a gaze-signal that represents the direction of the user's gaze;
a display screen for displaying visual content to the user, wherein the visual content is acquired by a remote camera associated with a receiving computer;
the controller configured to:
determine a region of the visual content that the user is looking at based on the gaze-signal; and
modify the visual content that is displayed to the user on the display screen based on the determined region of the display screen that the user is looking at.

The controller may be configured to:
determine whether or not a person is present in the region of the visual content that the user is looking at; and
if a person is present, then: modify the visual content to zoom in on the person; and
if a person is not present, then: modify the visual content to zoom to predetermined field of view.

The controller may be configured to modify the visual content that is displayed to the user on the display screen by:
changing a field of view of the remote camera;
changing a direction of the remote camera;
changing a degree of zoom of the remote camera; and
changing a crop position of an image that has a wider field of view than is being displayed on the display screen as visual content.

The controller may be configured to modify the visual content that is displayed to the user on the display screen by:
sending a control signal to the receiving computer; or
performing image processing on images that are acquired by the remote camera.

According to a further aspect of the present disclosure, there is provided a computer-implemented method of operating a video conferencing system, the method comprising:
determining a region of a visual content that a user is looking at based on a gaze-signal; and
modifying the visual content that is displayed to the user on the display screen based on the determined region of the display screen that the user is looking at.

According to a further aspect of the present disclosure, there is provided a controller for a video conferencing system, wherein the video conferencing system includes:
an eye tracking system for identifying a user's eyes in the acquired images and providing a gaze-signal that represents the direction of the user's gaze;
a display screen for displaying visual content to the user, wherein the visual content is shared visual content that is also displayed to one or more remote users;
   the controller configured to:
determine a region of the shared visual content that the user is looking at based on the gaze-signal; and
generate a data stream such that it includes a representation of the region of the shared visual content that the user is looking at.

The controller may be configured to generate a video stream wherein the visual content that the user is looking at has a region of modified content in order to provide a graphical representation of the region of the visual content that the user is looking at.

The controller may be configured to:
receive one or more remote-gaze-signals, which represent direction of the gaze of one or more remote users that are viewing the shared visual content;
determine regions of the shared visual content that each of the user and the remote users are looking at based on the respective gaze-signal and remote-gaze-signals; and
generate a video stream such that it includes at least some of the shared visual content and also a graphical representation of the region of the visual content that at least one of the user and the remote users are looking at.

The controller may be configured to:
receive a user-selection-signal that identifies one or more of the user and remote users as selected users; and
generate the video stream such that it includes a graphical representation of the region of the visual content that the selected users are looking at.

According to a further aspect of the present disclosure, there is provided a computer-implemented method of operating a video conferencing system, the method comprising:
determining a region of shared visual content that a user is looking at based on a gaze-signal; and
generating a data stream such that it includes a representation of the region of the shared visual content that the user is looking at.

According to a further aspect of the present disclosure, there is provided a controller for a video conferencing system, wherein the video conferencing system includes:
an eye tracking system for identifying a user's eyes in the acquired images and providing a gaze-signal that represents the direction of the user's gaze;
a display screen for displaying visual content to the user;
   the controller configured to:
determine a region of the visual content that the user is looking at based on the gaze-signal;
determine an identifier of visual content that is being displayed in the region of the display screen that the user is looking at; and
if the determined identifier represents an incoming video stream from a remote user that includes an image of a remote user, then generate a data stream such that it includes an identifier of the remote user.

The controller may further comprise the functionality of a central controller that is configured to:
receive a plurality of determined identifiers for a plurality of respective users; and
combine the plurality of determined identifiers in order to provide a consolidated-feedback-signal.

According to a further aspect of the present disclosure, there is provided a method of operating a video processing system, the method comprising:
determining a region of visual content that a user is looking at based on a gaze-signal;
determining an identifier of visual content that is being displayed in the region of the display screen that the user is looking at; and
if the determined identifier represents an incoming video stream from a remote user that includes an image of a remote user, then generating a data stream such that it includes an identifier of the remote user

According to a further aspect of the present disclosure, there is provided a controller for a computing system, wherein communication system includes a camera for acquiring images, wherein the controller is configured to:
recognise a status-stimulus by determining a status of a user in an acquired image; and
provide a visual representation of the status-stimulus to other users of the communications system.

The visual representation of the stimulus comprises one or more visual characteristics that are set based on the recognised status-stimulus.

The status-stimulus may comprise one or more of a looking-stimulus, a not-looking-stimulus, a present-stimulus and an absent-stimulus.

The controller may be further configured to:
recognise the looking-stimulus by determining that an acquired image shows the user to be looking towards the camera or a display screen, and in response provide a visual representation of the user looking towards the camera; and/or
recognise the not-looking-stimulus by determining that an acquired image shows the user that is not looking towards the camera or the display screen, and in response provide a visual representation of the user looking away the camera; and/or
recognise the present-stimulus by determining that the user is visible in an acquired image, and in response provide a visual representation of the user; and/or
recognise the absent-stimulus by determining that the user is not visible in an acquired image, and in response provide a visual representation that indicates the absence of the user.

The controller may further comprise the functionality of a central controller that is configured to:
receive a plurality of visual representations of the status-stimuli of a plurality of respective users of the communications system; and
present the plurality of visual representations to users of the communications system.

According to a further aspect of the present disclosure, there is provided a computer-implemented method of operating a computing system, the method comprising:
recognising a status-stimulus by determining a status of a user in an acquired image; and
providing a visual representation of the status-stimulus to other users of the communications system.

According to a further aspect of the present disclosure, there is provided a controller for a communications system, wherein the communications system includes:
a camera for acquiring images;
an eye tracking system for identifying a user's eyes in the acquired images and providing a gaze-signal that represents the direction of the user's gaze;
a display screen for displaying visual content to the user, including one or more representations of other users of the communications system;
   the controller configured to:
determine a region of the display screen that the user is looking at based on the gaze-signal;
identify one of the other users of the communications system that is associated with the determined region of the display screen that the user is looking at as a selected-other-user; and
in response to identifying the selected-other-user, facilitate a communication exchange between the user and the selected-other-user.

The controller may be configured to facilitate the communication exchange between the user and the selected-other-user by inserting text into a chat message with the selected-other-user based on subsequently received keystrokes.

The controller may be configured to facilitate the communication exchange between the user and the selected-other-user by opening a chat history with the selected-other-user and inserting text into the chat history as a new chat message based on subsequently received keystrokes.

The controller may be configured to facilitate the communication exchange between the user and the selected-other-user for a predetermined period of time after the controller identifies the selected-other-user.

The controller may be configured to facilitate the communication exchange between the user and the selected-other-user while the controller determines that the user is looking at the selected-other-user.

The video conferencing system may include a microphone for acquiring audio data. The controller may be configured to facilitate the communication exchange between the user and the selected-other-user by transferring subsequently acquired audio data to the selected-other-user.

The controller may be configured to transfer the subsequently acquired audio data to the selected-other-user in real-time.

The controller may be configured to:
record the subsequently acquired audio data to the selected-other-user;
convert the recorded audio data to text; and
transmit the text to the selected-other-user.

According to a further aspect of the present disclosure, there is provided a computer-implemented method of operating a communications system, the method comprising:
determining a region of a display screen that the user is looking at based on a gaze-signal;
identifying one of the other users of the communications system that is associated with the determined region of the display screen that the user is looking at as a selected-other-user; and
in response to identifying the selected-other-user, facilitating a communication exchange between the user and the selected-other-user.

According to a further aspect of the present disclosure, there is provided a controller for a computing system, wherein the computing system includes a sensor for providing sensor-signalling that represents one or more characteristics of a user that affect their wellbeing, and wherein the controller is configured to:
determine a wellbeing status of the user based on the sensor-signalling;
transmit a representation of the wellbeing status to other users of the computing system.

The controller may be further configured to determine the wellbeing status by aggregating the sensor-signalling, or information derived from the sensor-signalling, over a period of time.

The sensor for providing the sensor-signalling may comprise one or more of: a camera, an eye tracking system, a microphone, a time of flight sensor, radar, and ultrasound. The wellbeing status may represent one or more of: user attentiveness, eye openness patterns, time since last break, screen time vs break time, emotional state, various different gaze metrics.

The controller may be configured to:
determine a non-binary wellbeing score for the user based on the sensor-signalling; and
transmit a representation of the wellbeing score to the other users of the computing system.

The controller may be configured to:
generate a graphical representation of the wellbeing score; and
transmit the graphical representation to other users of the computing system.

The controller may be configured to:
generate a video stream based on acquired images of the user and also based on the graphical representation.

The controller may be configured to:
generate a video stream based on acquired images of the user that includes meta-data that represents the wellbeing score.

The sensor may be a camera and the sensor-signalling represents acquired images. The controller may be configured to:
process the acquired images in order to identify a user taking a break;
cause times associated with identified breaks to be recorded in memory; and
transmit a representation of the recorded times of the identified breaks to other users of the computing system.

The controller may be configured to:
determine how long the user has been at their computer since their last break as an active-duration; and
transmit the active-duration to other users of the computing system.

The controller may be configured to transmit the active-duration to one of the other users of the computing system in response to a request from the other user.

The request may comprise the other user positioning a cursor over an icon that represents the user.

The controller may be configured to:
determine how long the user has been at their computer since their last break as an active-duration; and
set a visual characteristic of an icon that represents the user to the other users based on the determined active-duration.

The controller may be configured to set the colour of a component of the icon that represents the user to the other users based on the determined active-duration.

The controller may be configured to:
determine how long the user has been at their computer since their last break as an active-duration; and
if the active-duration is greater than a threshold, then automatically generate an alert for the user.

The controller may be configured to:
determine how long the user has been at their computer since their last break as an active-duration; and
if the active-duration is greater than a threshold, then automatically generate an alert for the other users.

The controller may be configured to process the acquired images in order to identify a user taking a break by:
recognising a present-stimulus by determining that a user is visible in an acquired image;
recognising an absent-stimulus by determining that a user is not visible in an acquired image; and
identifying a break if the controller determines an absent-stimulus for at least a predetermined period of time.

The controller may further comprise the functionality of a central controller that is configured to:
receive details of the recorded times of the identified breaks of a plurality of users;
combine the details of the recorded times of the identified breaks of the plurality of users to provide combined-break-details; and
transmit a representation of the combined-break-details to other users of the computing system.

According to a further aspect of the present disclosure, there is provided a computer-implemented method of operating a computing system, the method comprising:
determining a wellbeing status of the user based on the sensor-signalling; and
transmitting a representation of the wellbeing status to other users of the computing system.

According to a further aspect of the present disclosure, there is provided a controller for a computing system, wherein the computing system comprises:
a first camera for acquiring first images of a first user watching video content on a first display; and
a second camera for acquiring second images of a second user watching the same video content on a second display;
   the controller configured to:
recognise a first-stimulus in one or more images acquired by the first camera, and identify a corresponding first portion of the video content that was being displayed to the first user;
recognise a second-stimulus in one or more images acquired by the second camera, and identify a corresponding second portion of the video content that was being displayed to the second user;
identify portions of the video content that have been identified as both a first portion and a second portion as highlight-portions; and
provide an output-video based on the highlight-portions.

The first-stimulus may be the same as the second-stimulus. The first-stimulus may be different to the second-stimulus.

The first-stimulus and/or the second-stimulus may comprise one or more of:
an emotional-stimulus;
a gesture-stimulus;
a looking-stimulus or not-looking-stimulus;
a status-stimulus;
a present-stimulus or an absent-stimulus.

According to a further aspect of the present disclosure, there is provided a computer-implemented method of operating a computing system, the method comprising:
recognising a first-stimulus in one or more images acquired by a first camera, and identifying a corresponding first portion of the video content that was being displayed to a first user;
recognising a second-stimulus in one or more images acquired by a second camera, and identify a corresponding second portion of the video content that was being displayed to a second user;
identifying portions of the video content that have been identified as both a first portion and a second portion as highlight-portions; and
providing an output-video based on the highlight-portions.

According to a further aspect of the present disclosure, there is provided a controller for a video processing system, wherein the controller is configured to:
receive acquired images;
recognise a person in the acquired images in order to determine an identifier associated with the recognised person;
if the determined identifier is on a list of protected-identifiers, then generate a video stream based on the acquired images by manipulating the visual representation of the second person in the acquired images; or
if the determined identifier is on a list of permitted-identifiers, then generate a video stream based on the acquired images without manipulating the visual representation of the second person in the acquired images.

According to a further aspect of the present disclosure, there is provided a method of controlling a video processing system, the method comprising:
receiving acquired images;
recognising a person in the acquired images in order to determine an identifier associated with the recognised person;
if the determined identifier is on a list of protected-identifiers, then generating a video stream based on the acquired images by manipulating the visual representation of the recognised person in the acquired images; or
if the determined identifier is on a list of permitted-identifiers, then generating a video stream based on the acquired images without manipulating the visual representation of the recognised person in the acquired images.

According to a further aspect of the present disclosure, there is provided a controller for a video processing system, wherein the controller is configured to:
receive acquired images;
identify a person in the acquired images;
run an age-estimation algorithm on the identified person to provide an estimated-age-value, which represents the estimated age of the identified person;
if the estimated-age-value is less than a threshold, then generate a video stream based on the acquired images by manipulating the visual representation of the identified person in the acquired image.

According to a further aspect of the present disclosure, there is provided a method of controlling a video processing system, the method comprising:
receiving acquired images;
identifying a person in the acquired images;
running an age-estimation algorithm on the identified person to provide an estimated-age-value, which represents the estimated age of the identified person;
if the estimated-age-value is less than a threshold, then generating a video stream based on the acquired images by manipulating the visual representation of the identified person in the acquired image.

There is also provided a video conferencing system comprising:
at least one transmitting computer; and
at least one receiving computer in communication with the at least one transmitting computer;
wherein the at least one transmitting computer includes an image transmission system and an audio transmission system;
wherein the transmitting computer is configured to modify an image transmitted by the image transmission system to the at least one receiving computer in response to at least one stimulus;
wherein the at least one stimulus include the presence or absence of a user and/or onlooker of the transmitting computer.

The modifying of the image may include one or more of:
lowering the resolution of all or part of the image;
blurring all or part of the image;
replacing the image with another image; and
ceasing transmission of the image.

The at least one stimulus may includes the gaze or attention of the user and/or onlooker.

The audio transmission system may continue to transmit without modification.

There is also disclosed a method of operating a video conferencing system, comprising:
modifying an image transmitted from a transmitting computer to a receiving computer in response to at least one stimulus;
wherein the at least one stimulus includes the present or absence of a user or onlooker of the transmitting computer.

There is also disclosed a video conferencing system comprising:
at least one transmitting computer; and
at least one receiving computer in communication with the at least one transmitting computer;
wherein the at least one transmitting computer includes an image transmission system and an audio transmission system;
wherein the transmitting computer is configured to replace an image of the user, transmitted by the image transmission system to the at least one receiving computer, with a virtual avatar of the user.

There is also provided a system comprising any controller disclosed herein.

There is also provided a controller, system or method that includes a plurality of the individual aspects as defined above or elsewhere in this disclosure.

There may be provided a computer program, which when run on a computer, causes the computer to configure any apparatus, including a circuit, controller or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform any method disclosed herein.

### SHORT DESCRIPTION OF FIGURES

One or more embodiments will now be described by way of example only with reference to the accompanying drawings in which:

FIG. 1 shows an example video conferencing system;

FIG. 2 shows a simplified view of an eye tracking system;

FIG. 3 shows a simplified example of an image of a pair of eyes, captured by an eye tracking system such as the system of FIG. 2;

FIG. 4 shows an example embodiment of a video conferencing system;

FIGS. 5A, 5B and 5C show screenshots of a video stream that will be used to describe how a controller can modify/generate the video stream in response to recognising a status-stimulus;

FIG. 6 shows a screen shot of visual content that can be displayed to a user on a display screen, and that will be used to describe how the controller of FIG. 4 can determine a read-status-stimulus;

FIG. 7 shows another example embodiment of a video conferencing system;

FIG. 8 is a schematic drawing of a user providing a gesture to a camera, which will be used to describe how the user can provide a control signal to a receiving computer for adjusting an operational parameter of a camera associated with the receiving computer;

FIG. 9 shows a screen shot of visual content that can be displayed to a user on a display screen, and that will be used to describe how a controller of a video conferencing system can generate a video stream that includes a graphical representation of the region of the visual content that the user is looking at;

FIG. 10 shows an example of a user's screen that shows how visual representations of a status-stimulus of a user of a computing system can be shared between users;

FIGS. 11A to 11E show a sequence of five screenshots that will be used to describe a method of facilitate a communication exchange between the user and another user;

FIGS. 12A and 12B show a sequence of two screenshots that will be used to describe a method of sharing information about a user's activity with other users of a computing system;

FIG. 13 shows an example of a computing system, which is usable for a plurality of users to watch the same video content; and

FIG. 14 shows schematically a computer implemented method of operating a video conferencing system according to the present disclosure.

### DESCRIPTION

Video Conferencing

Video conferencing and video streaming systems can be provided that act to limit issues relating to privacy. Any reference herein to a video conferencing system can be considered as encompassing a video streaming system. The present disclosure has a number of distinct functions, which may be utilised individually, together, or in any combination, in order to provide an increased level of privacy to a user.

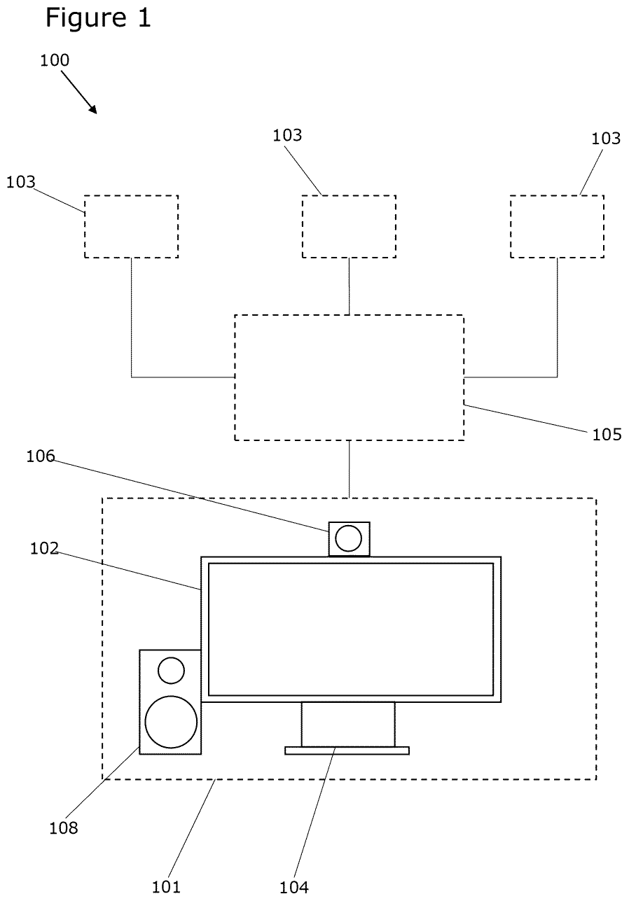

An example video conferencing system 100 is shown in FIG. 1. The video conferencing system includes a plurality of computers 101, 103, each of which is in communication, either wired or wireless, with a central server 105. In turn, the server 105 hosts the video conference and provides a single point of access for each of the computers 101, 103.

One of the computers 101 is shown in detail, but it will be understood that each of the computers 103 may include any of the features of the described computer 101. Where two-or-more-way video conferencing is required, each computer 101, 103 may be configured to include all of the features required for such video conferencing, including ways of collecting and transmitting video and audio feeds. However, the video conferencing system is to be utilised in a manner whereby one person transmits video and audio and the others transmit only one of video or audio or neither video nor audio, the configurations of the computers 101, 103 may be provided accordingly.

The computer 101 includes a display 102, a processor/controller 104, and a camera system 106. The camera system 106 includes a microphone such that the video conferencing may include both video and audio. The camera system 106 captures/acquires images of a user during use of the video conferencing system. The display 102 shows images from others partaking in the video conference and generally also shows an image of the user of the computer 101. A speaker 108 receives audio from the other computers 103 and plays this to the user of the depicted computer 101.

The term “processing” as used herein is generally intended to include processing both locally on each computer and processing externally, such as on the external server. Unless otherwise indicated, processing operations may take place entirely on the computer, entirely on the remote server, or partially in both the computer and the remote server. Additionally, although the example video conferencing system is shown as communicating with a server, in other examples the video conferencing system may be serverless, whereby one or more of the computers host the video conferencing locally, and all processing is carried out on one or more of the local computers.

The system 100 can be used to provide one or more of the functions described herein, each of the which may be utilised independently or in combination with any one or more of the other described functions.

Eye Tracking

In eye tracking applications, digital images are retrieved of the eyes of a user and the digital images are analysed in order to estimate the gaze direction of the user. The estimation of the gaze direction may be based on computer-based image analysis of features of the imaged eye. One known example method of eye tracking includes the use of infrared light and an image sensor. The infrared light is directed towards the pupil of a user and the reflection of the light is captured by an image sensor. However, it will be appreciated that an eye tracking system can be a purely software-implemented system that can process images that are provided by a standard webcam or other camera that records images of visible. That is, an eye tracking system does not necessarily required specialist hardware.

Many eye tracking systems estimate gaze direction based on identification of a pupil position together with glints or corneal reflections.

Portable or wearable eye tracking devices have also been previously described. One such eye tracking system is described in U.S. Pat. No. 9,041,787 (which is hereby incorporated by reference in its entirety). A wearable eye tracking device is described using illuminators and image sensors for determining gaze direction.

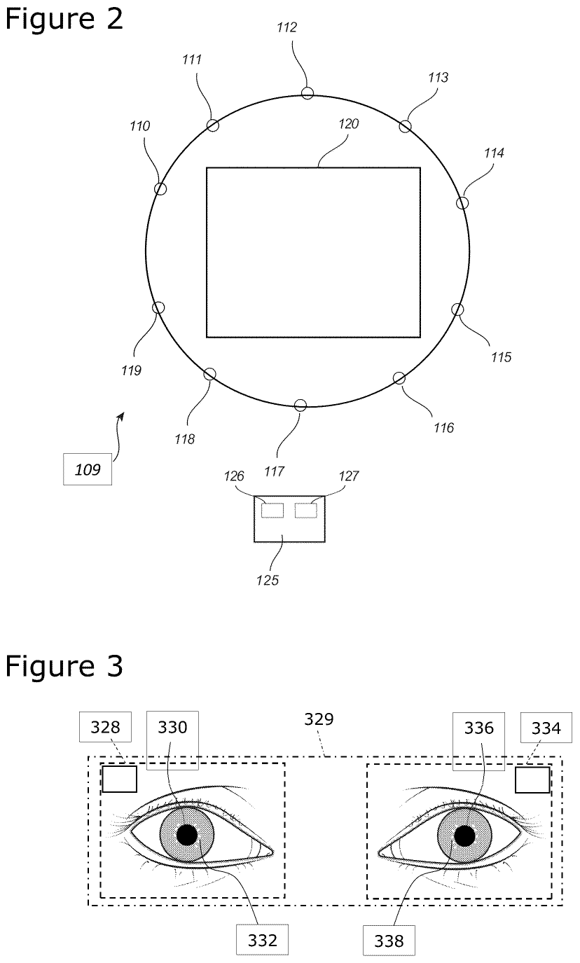

FIG. 2 shows a simplified view of an eye tracking system 109 (which may also be referred to as a gaze tracking system) in a head-mounted device in the form of a virtual or augmented reality (VR or AR) device or VR or AR glasses or anything related, such as extended reality (XR) or mixed reality (MR) headsets. The system 109 comprises an image sensor 120 (e.g. a camera) for capturing images of the eyes of the user. The system may optionally include one or more illuminators 110-119 for illuminating the eyes of a user, which may for example be light emitting diodes emitting light in the infrared frequency band, or in the near infrared frequency band and which may be physically arranged in a variety of configurations. The image sensor 120 may for example be an image sensor of any type, such as a complementary metal oxide semiconductor (CMOS) image sensor or a charged coupled device (CCD) image sensor. The image sensor may consist of an integrated circuit containing an array of pixel sensors, each pixel containing a photodetector and an active amplifier. The image sensor may be capable of converting light into digital signals. In one or more examples, it could be an Infrared image sensor or IR image sensor, an RGB sensor, an RGBW sensor or an RGB or RGBW sensor with IR filter.

The eye tracking system 109 may comprise circuitry or one or more controllers 125, for example including a receiver 126 and processing circuitry 127, for receiving and processing the images captured by the image sensor 120. The circuitry 125 may for example be connected to the image sensor 120 and the optional one or more illuminators 110-119 via a wired or a wireless connection and be co-located with the image sensor 120 and the one or more illuminators 110-119 or located at a distance, e.g. in a different device. In another example, the circuitry 125 may be provided in one or more stacked layers below the light sensitive surface of the light sensor 120.

The eye tracking system 109 may include a display (not shown) for presenting information and/or visual prompts to the user. The display may comprise a VR display which presents imagery and substantially blocks the user's view of the real-world or an AR display which presents imagery that is to be perceived as overlaid over the user's view of the real-world.

The location of the image sensor 120 for one eye in such a system 109 is generally away from the line of sight for the user in order not to obscure the display for that eye. This configuration may be, for example, enabled by means of so-called hot mirrors which reflect a portion of the light and allows the rest of the light to pass, e.g. infrared light is reflected, and visible light is allowed to pass.

While in the above example the images of the user's eye are captured by a head-mounted image sensor 120, in other examples the images may be captured by an image sensor that is not head-mounted. Such a non-head-mounted system may be referred to as a remote system.

FIG. 3 shows a simplified example of an image 329 of a pair of eyes, captured by an eye tracking system such as the system of FIG. 2. The image 329 can be considered as including a right-eye-image 328, of a person's right eye, and a left-eye-image 334, of the person's left eye. In this example the right-eye-image 328 and the left-eye-image 334 are both parts of a larger image of both of the person's eyes. In other examples, separate image sensors may be used to acquire the right-eye-image 328 and the left-eye-image 334.

The system may employ image processing (such as digital image processing) for extracting features in the image. The system may for example identify the location of the pupil 330, 336 in the one or more images captured by the image sensor. The system may determine the location of the pupil 330, 336 using a pupil detection process. The system may also identify corneal reflections 332, 338 located in close proximity to the pupil 330, 336. The system may estimate a corneal centre or eye ball centre based on the corneal reflections 332, 338. For example, the system may match each of the individual corneal reflections 332, 338 for each eye with a corresponding illuminator and determine the corneal centre of each eye based on the matching. The system can then determine a gaze ray (which may also be referred to as a gaze vector) for each eye including a position vector and a direction vector. The gaze ray may be based on a gaze origin and gaze direction which can be determined from the respective glint to illuminator matching/corneal centres and the determined pupil position. The gaze direction and gaze origin may themselves be separate vectors. The gaze rays for each eye may be combined to provide a combined gaze ray. One or more of the gaze rays/vectors described above may be provided as part of a gaze-signal that is provided by the eye tracking system that represents the direction of the user's gaze.

User Presence

Returning to FIG. 1, the computer 101 may detect a user's presence by any number of means. In the depicted embodiment, user presence may typically be detected by use of the camera 106 associated with the computer 101. Other methods of user detection may include the use of an eye tracking device, such as the Tobii Eye Tracker 5, developed by the applicant. Other methods of presence detection will be known to the skilled person.

When it is detected that the or a user is not present, the video conferencing system 100 may stop the user's video feed or otherwise adapt the video feed. Other adaptations of the video feed may include lowering the resolution of the image—e.g. blurring the image—or freezing the video feed to use a static image. Whilst the image is frozen, removed, or provided at a lower resolution, the audio feed between the user and the video conferencing system 100 may be continued. Thus, audio contact can be maintained even when the user is not detected before the computer 101. However, by adapting the video feed, bandwidth usage can be lowered, and privacy of the user can be maintained.

In some embodiments, it may be advantageous to allow the user to customise the video feed provided to others on the video conferencing system 100. For example, a user, such as a game streamer, may choose to display static or moving advertisements when away from the computer 101, or another user may opt to display a video or image of themselves in order to appear present at the computer 101 when they are, in fact, absent.

User Attention

The system 100 may be adapted to provide video and/or audio effects based on the presence of the user and/or whether the user is paying attention to the computer 101 at any instant. Awareness of the attention may be determined through use of a gaze detection algorithm operating on the input provided by the camera 106, or by another means such as the aforementioned eye tracking system.

The system 100 may provide any one or more of the features described in the section titled “User Presence”, but instead of user presence being the deciding factor to implement the feature, the attention of the user may instead be the guiding factor.

Avatar Use

In some situations, it may be desirable for a user to utilise an avatar in place of their own video. The use of avatars can allow virtual rendering of head movement, facial expressions, and other features of the user, whilst protecting their general privacy by not showing their actual face. It may also be possible to reduce bandwidth use by using a rendered avatar rather than a full-resolution transmission of a user image.

User Behaviour (Including Presence, Attention and Avatar Use)

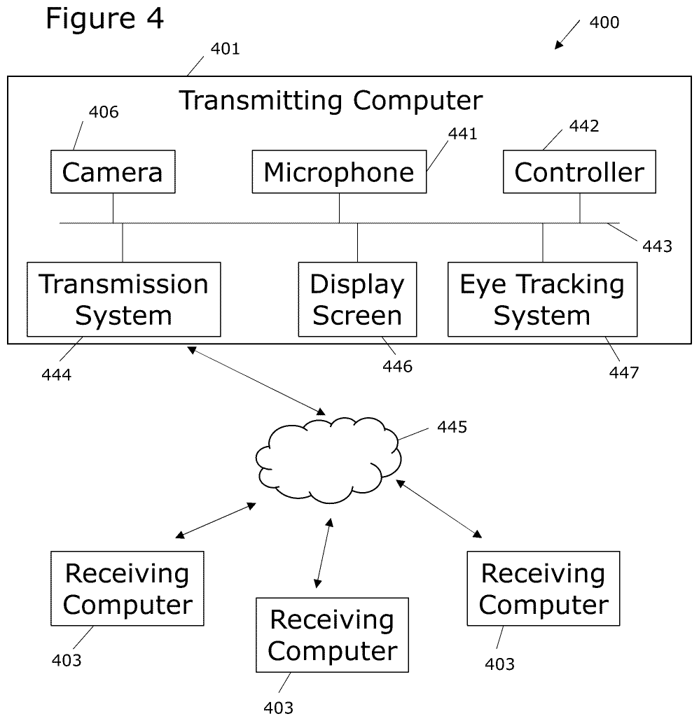

FIG. 4 shows an example embodiment of a video processing system 400, which in this example is a video conferencing system. The video conferencing system 400 in this example includes one transmitting computer 401 and three receiving computers 403, although it will be appreciated that each of the receiving computers 403 can also provide the functionality of a transmitting computer 401, and vice versa. Furthermore, one or more of the examples disclosed herein can apply to video processing systems that are not necessarily used for two-way (or more) communication. For example, it will be appreciated that some of the functionality described herein can be equally applicable to video broadcasting/streaming systems that are not required to receive a video stream in return from a remote computer.

The transmitting computer 401 includes a camera 406 for acquiring images, a microphone 441 for acquiring audio data, a controller 442, a transmission system 444 for transmitting a video stream to a receiving computer 403, a display screen 446 for displaying visual content to a user, and an eye tracking system 447. As indicated above, the eye tracking system 447 may or may not require bespoke hardware—instead it could be implemented in software such that it processes images acquired by the camera 406. Each of the components of the transmitting computer 401 are in communication with each other via a bus 443. It will be appreciated that not all of the components of the transmitting computer 401 that are shown in FIG. 4 are required to provide the functionality that is described below, in which case various of the components can be considered as optional.

In this example, the controller 442 can recognise a stimulus in one or more acquired images and generate the video stream based on the acquired images, and also set a characteristic of the video stream based on the recognised stimulus. In this way, a different/modified video stream can be generated when a stimulus is recognised in the acquired images. Various examples of stimuli and ways of modifying the video stream are provided below.

In the majority of the examples that follow, a description will be provided that relates to the controller recognising a stimulus in one or more acquired images that are provided by a local camera. However, in other examples, the recognition of a stimulus may be performed at a controller/computer that is remote from the camera that acquired the images. In which case, the controller receives and processes images that are acquired by a remote camera.

In various examples, the video stream includes one or more of video data, audio data and meta-data. Correspondingly, the transmission system can include a video/image transmission system and/or an audio transmission system. The controller 442 can be configured to set a characteristic of the video stream (which can also be referred to as modifying one or more aspects of the video stream in this document) in response to recognising the stimulus. That is, the controller can set a characteristic of one or more of the video data, the audio data and/or the meta-data of a video stream. Modifying the video data can be considered as modifying an image transmitted by an image transmission system to at least one receiving computer. Modifying (or setting a characteristic of) meta-data can include setting a value of a status for the user, setting a value that indicates the selection of a reaction (such as an emoji), etc.

In an example, the controller 442 can recognise a status-stimulus by determining a status of a user in an acquired image that is provided by the camera 406. The status-stimulus can comprise one of a looking-stimulus, a not-looking-stimulus, a present-stimulus and an absent-stimulus.

The controller 442 can perform image processing on the acquired image to recognise the looking-stimulus by determining that an acquired image shows a user to be looking towards the camera 406 or the display screen 446. The controller 442 can recognise the looking-stimulus by determining the direction of the user's head and/or by determining the direction of the user's gaze, optionally with reference to the position of the user's head/eyes in the acquired image. This can involve determining that the direction of the user's head/gaze is within a predetermined angle with reference to a centre or a periphery of the camera/screen. As a further example, the controller 442 can also recognise the looking-stimulus by determining that both of the user's eyes are visible in the acquired image. More generally, the controller 442 can recognise the looking-stimulus using any method that is known in the art, including the application of a machine learning or a non-machine learning algorithm. Determining the direction of the user's gaze may or may not utilise bespoke eye tracking hardware such as that described above with reference to FIG. 2. Examples of image processing that can be used to determine the direction of a user's head or eyes is well-known in the art.

In a similar way, the controller 442 can perform image processing on the acquired image to recognise the not-looking-stimulus by determining that an acquired image shows a user that is not looking towards the camera 406 or the display screen 446. The controller 442 can recognise the not-looking-stimulus by determining the direction of the user's head and/or by determining the direction of the user's gaze.

Advantageously, implementation of a controller 442 that can identify a looking-stimulus and a not-looking-stimulus, and can set a characteristic of the video stream based on the recognised looking-stimulus or the not-looking-stimulus, can greatly improve the social interaction with that user

The controller 442 can perform image processing on the acquired image to recognise the present-stimulus by determining that a user is present in an acquired image. This can include determining that a user is visible in the acquired image or determining that a user's face is visible in the acquired image. Algorithms for recognising a person, including algorithms for recognising a person's face and the presence of a person, are well known in the art. As will be discussed below, the controller 442 can recognise the present-stimulus by determining that a specific user is visible in an acquired image (such as one that has is identified on a list of permitted users), or by recognising that any user/person is visible in the acquired image. In an example where the looking-stimulus can also be recognised, the present-stimulus can be considered as a not-looking stimulus because it is recognised by determining that a user is visible in an acquired image AND by determining that the user (their eyes or their head) is not looking towards the camera 406/display screen 446.

The controller 442 can perform image processing on the acquired image to recognise the absent-stimulus by determining that a user is not present/visible in an acquired image. Such a recognition can be determined by using the same image processing algorithm that is used to recognise the present-stimulus. Again, the controller 442 can recognise the absent-stimulus by determining that a specific user is not present/visible in an acquired image, or by recognising that no users/persons are visible in the acquired image.

In an example where the video stream comprises status data, the controller 442 can modify/set a characteristic of the video stream by setting the status data in response to recognising the status-stimulus. Setting the status data may involve setting a value in meta-data that is part the video stream. Advantageously, such processing involves automatically recognising the presence/attention of the user and sharing that information with other users of the video conferencing system by setting the user's status accordingly. Automatically recognising and sharing such status information can result in improved interactions between users of the video conferencing system.

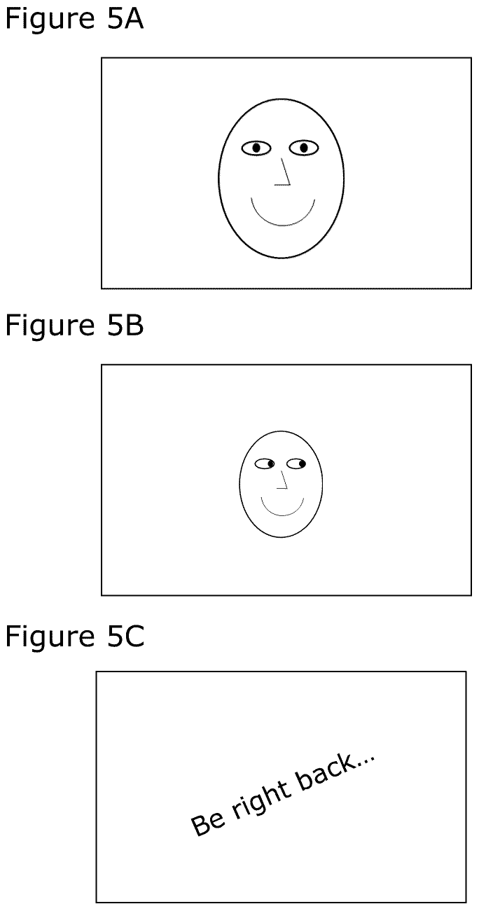

FIGS. 5A, 5B and 5C show screenshots of a video stream that will be used to describe how a controller can modify/set a characteristic of the video stream in response to recognising a status-stimulus.

FIG. 5A shows a screenshot of a video stream, for which a looking-stimulus has been identified in the corresponding images acquired by the camera. In this example, the controller has applied a zoom to the acquired image such that the video stream includes images that are more zoomed-in than would be the case if the looking-stimulus had not been recognised (as can be seen by comparing FIG. 5A with FIG. 5B). The additional zoom can be achieved by modifying an optical zoom of the camera or by modifying a digital zoom level of the acquired image, thereby cropping out the periphery of the acquired image. In this way, a zoom characteristic of the video stream/video data can be set. Additionally or alternatively, the controller can set a colour level of the video stream such that it is different to a colour level that is applied if the looking-stimulus is not recognised. For instance, the video stream can be in colour if the looking-stimulus is recognised, but in black and white if it is not. In this way, additional attention can be drawn to the user when they are engaged and looking at the camera/display screen, which in turn can improve the interaction between the users.

FIG. 5B shows a screenshot of a video stream, for which a not-looking-stimulus has been identified in the corresponding images acquired by the camera. In this example, the not-looking-stimulus has been recognised because the controller has determined that the user's eyes are not looking towards the camera. In FIG. 5B, the controller has modified the video stream in response to recognising the not-looking-stimulus by not applying a zoom to the acquired image, or by not applying as much zoom as is applied when the looking-stimulus is recognised (as shown in FIG. 5A). That is, the controller can apply a first zoom level to the acquired image when the looking-stimulus is recognised, and can apply a second zoom level to the acquired image when the not-looking-stimulus is recognised, wherein the first zoom level is greater than the second zoom level. Additionally or alternatively, the controller can set a colour level of the video stream such that it is different to a colour level that is applied if the looking-stimulus is recognised. For instance, the controller can set a colour level such that the video stream is in black and white if the not-looking-stimulus is recognised.

FIG. 5C shows a screenshot of a video stream, for which an absent-stimulus has been identified in the corresponding images acquired by the camera by the controller determining that a user is not visible in an acquired image. In this example, the controller has modified the video stream, in response to recognising the absent-stimulus, by replacing the acquired image with a replacement (static) image. The replacement image can include any message, such as the “Be right back . . . ” message in FIG. 5C. In alternative embodiments, the controller can set a characteristic of the video stream by: lowering the resolution of all or part of the acquired image; blurring all or part of the acquired image; or ceasing transmission of the video stream.

By taking one or more of these actions in response to recognising an absent-stimulus, internet bandwidth usage can be reduced and privacy can be enhanced. This can be useful if users keep video calls on even when they are not present in front of the computer. In group video calls, streaming video in high resolution consumes large bandwidth, and users often resort to turning off the video to overcome the bandwidth issues. Therefore, automatically reducing bandwidth usage when a user is absent from their video feed can be beneficial.

In one or more of these examples, the video stream can include an audio stream (based on audio data acquired by a microphone) irrespective of the status-stimulus. This includes continuing a two-way audio feed even if an absent-stimulus is recognised. Alternatively, the controller can modify the audio stream in response to recognising one or more of the looking-stimulus, the not-looking-stimulus and the absent-stimulus. Such modification of the audio stream can include muting/removing the audio stream.

In some examples, the controller can take specific action when recognising that the absent-stimulus is no longer present (i.e. a or the user is visible again in the acquired images). For instance, following recognition of an absent-stimulus, the controller can recognise a present-stimulus by determining that a predetermined user is visible in an acquired image. In response, the controller can generate the video stream based on the acquired image and unset the characteristic of the video stream that was set in response to recognising the absent-stimulus. In this way, any modifications to the video stream that were applied in response to recognising the absent-stimulus can be removed.

Optionally, the controller can determine the identify a user in an acquired image before the recognition of the absent-stimulus. In this way, the controller can store the identity of the user who has left the field of view of the camera so that the identity of a person who appears in a subsequently acquired image can be checked against the identity of the person who was visible in the acquired images before the absent-stimulus was recognised. That is, the controller can recognise the present-stimulus (subsequent to an absent-stimulus) by determining that the identified user (from the images before the absent-stimulus was recognised) is visible in a current acquired image. Therefore, the controller will only recognise the present-stimulus when the same user reappears in the acquired images, and not when another (potentially unrelated) person happens to walk past the camera. It will be appreciated that algorithms are known in the art for recognising the identity of people.

One or more of the above examples relate to the controller setting a characteristic of the video stream based on the recognised stimulus (such as the looking-stimulus, the not-looking-stimulus and the absent-stimulus) by applying a predetermined operation to the acquired images. The predetermined operation can include one or more of: setting a status value or other meta-data value, setting the zoom of the video stream, setting the colour level of the video stream, lowering the resolution of all or part of the video stream, blurring all or part of the video stream, replacing the acquired image with a replacement image and/or ceasing transmission of the video stream. This can significantly increase the social presence that is achieved during the interaction between the users.

As another example, the controller can recognise an emotional-stimulus in one or more acquired images (either acquired by the local camera or received as an incoming video feed). The controller can then generate a video stream based on the acquired images, and set a characteristic of the video stream based on the recognised emotional-stimulus. Non-limiting examples of the emotional-stimulus include: a smiling-stimulus, a happy-stimulus, a frowning-stimulus, a sad-stimulus, an angry-stimulus, a crying-stimulus, a disgusted-stimulus, a fearful-stimulus, a surprised-stimulus, a neutral-stimulus, a winking-stimulus, a blinking-stimulus, a raising-eye-brows-stimulus, an opening-mouth-to-show-surprise-stimulus, an opening-mouth-to-show-awe-stimulus, a frowning-stimulus. Each of these emotions can be recognised by the controller performing image processing on the acquired images. For instance, a machine learning/artificial intelligence classification operation can be performed on the acquired images to recognise an emotional-stimulus. One or more of these stimuli can correspond to the basic emotions of: anger, disgust, happiness, fear, sadness, surprise and neutral. Also, one or more of these emotions can correspond to the emoting expressions of: smiling, winking, blinking, raising eye browse, opening mouth to show surprise or awe, frowning, etc.

In one implementation, the controller can set a characteristic of the video stream in response to recognising the emotional-stimulus by modifying the video stream to include a visual representation of the recognised emotional-stimulus. For instance, one or more emojis that correspond to the recognised emotional-stimulus can be embedded in the video stream. Additionally or alternatively, the controller can set the value of status data in the video stream in response to recognising the emotional-stimulus. As a yet further example, the controller can automatically activate a reaction in the video conferencing call that corresponds to the recognised emotional-stimulus (for example by setting an appropriate value in meta-data) such that other participants will receive an associated notification. That is, the controller can set meta-data of the video stream based on the recognised emotional-stimulus.

As a yet further example, the controller can recognise a gesture-stimulus in one or more images acquired by the camera. The controller can then set a characteristic of the video stream in response to recognising the gesture-stimulus.

Non-limiting examples of the gesture-stimulus include: a thumbs-up, a thumbs-down, a wave, clapping, and raising a hand. Again, each of these gestures can be recognised by the controller performing image processing on the acquired images in the same way that is described with reference to recognising emotional-gestures.

The controller can then modify the video stream in response to recognising the gesture-stimulus. For instance, the controller can modify the video stream in response to recognising the gesture-stimulus by: modifying the video stream to include a visual representation of the recognised gesture-stimulus (e.g. an icon of a thumbs-up overlaid on top of the video stream); setting the status data in response to recognising the gesture-stimulus; automatically activating a reaction in the video conferencing call that corresponds to the recognised gesture-stimulus such that other participants will receive an associated notification; or otherwise setting meta-data of the video stream based on the recognised gesture-stimulus.

In some examples the controller can modify the video stream in response to the recognition of an absent-stimulus such that the user appears present at their computer when they are, in fact, absent. This can be achieved by the controller automatically creating, and providing as an outgoing video stream, a looping video of historic video stream data (potentially only video stream data) during which the absent-stimulus was not recognised (such as the last n seconds that the user was present). Thus giving the impression that the user is still in the call when they are not. For example, the controller can cause a portion of the video stream to be stored in computer memory while the absent-stimulus is not recognised. In one implementation this is achieved by saving the video stream into a first-in-first-out buffer such that the most recent portions of the video conferencing are available in memory. When the controller recognises the absent-stimulus, it causes the contents of the computer memory (i.e. the historic portions of the video stream) to be provided as the outgoing video stream instead of the most recently acquired images and audio data.

This functionality can be further enhanced by the controller analysing the video stream to identify a suitable time loop extract/snippet in a preceding period of time (e.g. the last 30 seconds) before the user leaves (and the absent-stimulus is recognised). This would allow the user to still seem present in the same clothes and environment as while they were present. The analysis could be in terms of identifying user head movements to make a matching loop, and also e.g. by making sure that there are no obstructions such as the user taking a sip of coffee or touching their face. Additionally, by finding a time extract/snippet where the user is not talking. Such functionality can be implemented by the controller processing historic video stream data (that is stored in memory) and identifying extracts/clips of the stored video stream that do not contain any recognised stimuli (or at least do not include any predetermined types of stimuli, which are considered undesirable to be included in the time loop). The controller can then provide the outgoing video stream based on the identified extracts/clips of the stored video stream. For instance, by continuously looping through the identified subsets/clips.

Returning to FIG. 4, there follows a description of an example of a video system that recognises read-status-stimulus. In this example the video processing system is a video conferencing system, although in other examples the video processing system can be a video broadcasting/streaming system or any other video processing system that can benefit from being able to recognise that a user is reading text that is displayed on a display screen as visual content. In this example, the video conferencing system includes an eye tracking system 447, a display screen 446 and a controller 442. The eye tracking system 447 is for identifying a user's eyes in the acquired images and providing a gaze-signal that represents the direction of the user's gaze. The functionality of the eye tracking system 447 may be provided by software that processes images that are acquired by a standard webcam. Alternatively, the functionality of the eye tracking system 447 can be provided by bespoke eye tracking hardware such as that described above with reference to FIG. 2.

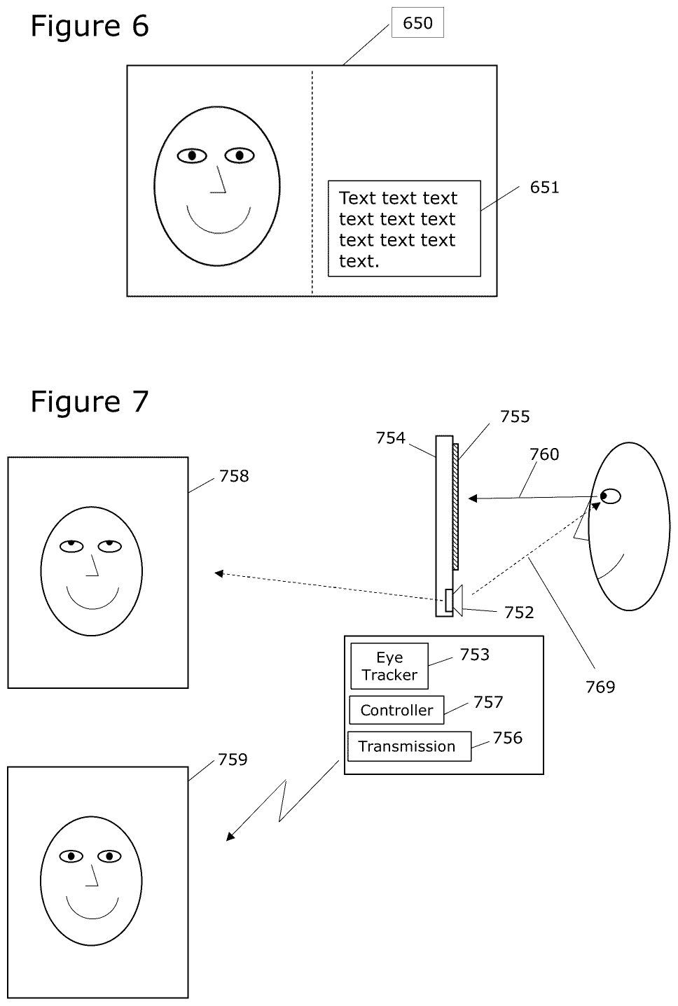

FIG. 6 shows a screen shot of visual content that can be displayed to a user on a display screen 650, and that will be used to describe how the controller of FIG. 4 can determine the read-status-stimulus.

As shown in FIG. 6, the display screen 650 is displaying visual content that includes text 651 to a user. In the example of FIG. 6, the text 651 is only in the bottom-right corner of the screen 650.

The controller can recognise the read-status-stimulus in one or more images based on the received gaze-signal. For example, the controller can process the gaze-signal and classify movements in the gaze-signal as corresponding to the user reading text. This can involve identifying fixation patterns in the gaze-signal over time that are known to occur when the user is reading. Such fixation patterns can be considered as a stuttering movement that occurs as a user's eyes move from word to word in the text, which is a known signature of a gaze signal that relates to the user reading. In this way, the controller can recognise the read-status-stimulus by recognising a pattern in the gaze-signal that is associated with eye movement as a user is reading.

The controller can generate a video stream based on the acquired images, and set a characteristic of the video stream based on the recognised read-status-stimulus. For instance, the controller can set status data in the video stream in response to recognising the read-status-stimulus. For instance, the controller can set the status data to a “reading” value and transmit the status data to other users of the video conferencing system. This can improve the social presence of the system. Furthermore, other users may be able to decide whether or not to interrupt the user in the knowledge that they are reading thereby further improving the interaction between the users.

In the above example the controller can recognise a read-status-stimulus irrespective of what is being displayed to the user on the display screen 650.

In a more sophisticated example, the controller can recognise the read-status-stimulus in one or more images based on: i) the received gaze-signal; and ii) a text-signal that represents text that is displayed to the user. Use if the text-signal can advantageously provide context to the gaze-signal such that a more accurate determination of the user's behaviour can be determined. The text-signal can represent one or more of:
a location on the display screen 650 that text 651 is displayed to the user;
the quantity of text 650 that is displayed to the user; and
the content of the text 650 that is displayed to the user.

If the text-signal represents the location on the display screen 650 that text 651 is displayed to the user, then it may be embodied as coordinates on the display screen 650 that the text 651 is displayed. For example, in FIG. 6 the text-signal can include coordinates that represent the bottom-right corner of the display screen 650. The controller can then only recognise the read-status-stimulus if the received gaze-signal is: i) indicative of the user reading (as discussed above); and ii) the gaze-signal indicates that the user is looking at a region of the display screen 650 that includes text 651 (as defined by the text-signal). More particularly, the controller can recognise a reading-stimulus (which is an example of a read-status-stimulus) when conditions i) and ii) are satisfied. If condition ii) is not satisfied, then potentially the user is reading something other than what is being displayed on their screen.

If the text-signal represents the quantity or content of text 650 that is displayed to the user, then it may be embodied as the number of words or lines of text 651 that are displayed, or the length of the words that are displayed, for example. Use of such a text-signal can enable the controller to recognise an unread-stimulus or a read-stimulus (as further examples of a read-status-stimulus). For example, in FIG. 6 the text-signal can include an indicator that there are 10 words in the text 651 that is displayed to the user. The controller can then recognise the read-stimulus if the received gaze-signal is: i) indicative of the user having read 10 words (as discussed above, this can be determined by recognising fixation patterns in the gaze-signal). This can advantageously provide context to the reading that is identified in the gaze-signal such that it is more accurately associated with what is being displayed to the user on their display screen 650. As an additional, optional, criteria the controller can only recognise the read-stimulus if the received gaze-signal also: ii) indicates that the user has been looking at a region of the display screen 650 that includes the text 651 (as defined by the text-signal). The controller can recognise an unread-stimulus if the read-stimulus has not been recognised.

In one example, the controller can modify the video stream by setting the status data in response to recognising the read-status-stimulus. As a further example, the controller can modify the video stream in response to recognising the read-status-stimulus by setting a visual property of the text that is to be shown on a remote user's display screen (for example by way of screen sharing) to indicate whether or not it has been read. For instance, a border around the text can be set to a first colour if the text has not been read and can be set to a second colour if the text has not been read.

In some examples, the text-signal can represent a plurality of distinct locations of text that are displayed to the user. The controller can then associate the recognised read-status-stimulus with one of the plurality of distinct locations of text based on: the received gaze-signal; and the text-signal; and set a visual property of the corresponding text that is displayed on the remote user's display screen accordingly.

FIG. 7 shows another example embodiment of a video conferencing system. In this example, the video conferencing system includes: a camera 752, an eye tracking system 753, a display screen 754, a transmission system 756, and a controller 757. The camera 752 is for acquiring images for providing as part of (or forming the basis of) a video stream to a remote user, in the same way as discussed above. The eye tracking system 753 is for identifying a user's eyes in the acquired images and providing a gaze-signal that represents the direction of the user's gaze. The display screen 754 is for displaying visual content 755 to the user. The transmission system 756 is for transmitting a video stream (including video data) to a receiving computer such that it can be viewed by a remote user.

FIG. 7 also shows an image 758 that is acquired by the camera 752 while the user is looking at the display screen 754. The user's gaze is schematically represented in FIG. 7 by arrow 760 to indicate that the user is looking at the visual content 755 on the display screen 754. Since the camera 752 is offset from the region of the display screen 754 that displays the visual content 755 (as is often the case), the user's eyes in the acquired image 758 are directed upwards (relative to the camera 752) whereas they are actually looking straight at the visual content 755.

The controller 757 is configured to determine a region of the display screen 755 that the user is looking at based on the gaze-signal provided by the eye tracking system 753, as is known in the art. The controller 757 can then determine an identifier of visual content that is being displayed in the region of the display screen that the user is looking at. Examples of visual content that can be displayed include: an incoming video stream from a remote user that includes an image of the remote user (or an avatar that represents the remote user); shared visual content (such as a shared screen); and visual content that is independent of the video conference call (such as the user's mailbox that is open on a different region of the display screen 754).

If the determined identifier represents an incoming video stream from a remote user that includes an image of the remote user (i.e. the user is looking at a collaborator with whom they are in a video call), then the controller 757 generates the video stream based on the acquired images by modifying the representation of the user's eyes in the video stream. More particularly, the controller 757 can modify the acquired image 758 to generate a video stream 759 in which the user's eyes are looking in a different direction to the user's eyes in the corresponding acquired images 758. This is shown schematically in FIG. 7 whereby the user's eyes are looking straight forward in the video stream 759, even though they are looking upwards in the acquired image 758. In this way, if the user is looking at visual content that represents another person on the call, the user's eyes are modified in the video stream 759 such that it appears as if the user is looking directly at the camera 752. Therefore, there is a perception that the user is making direct eye contact with the remote user, thereby improving the social interaction between the users.

If the determined identifier does not represent an incoming video stream from a remote user that includes an image of the remote user (i.e. the user is not looking at a collaborator), then the controller 757 can generate the video stream based on the acquired images 758 such that the representation of the user's eyes in the video stream are looking in the same direction as the user's eyes in the corresponding acquired images (i.e. there is no modification of the representation of the user's eyes when generating the video stream).

In some examples the controller can determine an offset between the direction of the user's gaze 760 as defined by the gaze-signal and a line of sight 769 between the user's eyes and the camera. Such a determination can include applying geometric operations based on a known position of the camera 752 relative to the screen 754, and the position of the user's eyes in the acquired image. Then, based on the determined offset, the controller can modify the representation of the user's eyes in the video stream 759 such that they are looking in a different direction to the user's eyes in the corresponding acquired images 758. More specifically, the controller can apply the determined offset to the direction of the user's gaze as defined by the gaze-signal in order to determine a corrected-gaze-direction; and generate the representation of the user's eyes such that they appear to be looking in the corrected-gaze-direction. This can advantageously maintain the relative motion of the user's eyes in the video stream 759, but recalibrated such that the user appears to be looking directly at the other user when they are looking at the other user's video feed on the display screen 754. For instance, the controller can generate the video stream in this way for a predetermined period of time after the user stops looking at the incoming video stream from the remote user such that video stream does not immediately flip back to the unmodified representation of the user's eyes.

In some examples, the controller 757 generates the video stream by replacing the user that is recognised in the acquired images with an avatar. Such processing is known in the art. Then, if the determined identifier represents an incoming video stream from a remote user, the controller 757 can generate the video stream 759 based on the acquired images such that the avatar's eyes in the video stream 759 are looking in a different direction to the user's eyes in the corresponding acquired images 758. Similarly, if the determined identifier does not represent an incoming video stream from a remote user, then the controller 757 can generate the video stream 759 based on the acquired images such that the avatar's eyes in the video stream 759 are looking in the same direction as the user's eyes in the corresponding acquired images 758.

In a further still example, the controller can apply a modification to the representation of the user's eyes in the video stream 759 irrespective of whether or not it is determined that the user is looking at a collaborator on the display screen 754. In such an example, the controller can determine an offset between the direction of the user's gaze as defined by the gaze-signal and a determined line of sight between the user's eyes and the camera; and based on the determined offset, modify the representation of the user's eyes in the video stream such that they are looking in a different direction to the user's eyes in the corresponding acquired images. Additionally, in some examples the controller can generate the video stream by replacing the user that is recognised in the acquired images with an avatar, and generate the video stream based on the acquired images such that the avatar's eyes in the video stream are looking in a different direction to the user's eyes in the corresponding acquired images.

FIG. 8 is a schematic drawing of a user 860 providing a gesture to a camera 861, which will be used to describe how the user 860 can modify the visual content that is displayed to the user on the display screen 862.

The example of FIG. 8 relates to a video conferencing system that includes: a (local) camera 861 for acquiring images of the user 860, an eye tracking system for identifying a user's eyes in the acquired images and providing a gaze-signal that represents the direction of the user's gaze, and a display screen 862 for displaying visual content 863 to the user 860. The visual content 863 is acquired by a remote camera (not shown) that is associated with the receiving computer. The video conferencing system can also include a transmission system for transmitting a video stream to the receiving computer, wherein the video stream comprises a video stream.

The video conferencing system also includes a controller (not shown). The controller can determine a region of the visual content that the user is looking at based on the gaze-signal; and modify the visual content that is displayed to the user on the display screen based on the determined region of the display screen that the user is looking at region of the visual content that the user is looking at. For example, the controller can cause the display screen 863 to show a zoomed in representation of the region of the visual content that the user is looking at, simply by recognising that the user is looking in that direction.

In one example, the controller can determine whether or not a person is present in the region of the visual content that the user is looking at. This may be one of a plurality of persons that are visible in the visual content. If a person is present, then the controller can modify the visual content to zoom in on the person. If a person is not present, then the controller can modify the visual content to zoom to predetermined/default field of view. For example, to a maximum field of view so that the user can see the entire scene at the other end (which may include a group of people). Such an example can improve the social interaction when a user is engaging with a group of people over a video conference, but adjusting the focus of the visual content based on a recognition of which individual from the group of people the user is addressing.

The controller can modify the visual content that is displayed to the user on the display screen by: changing a field of view of the remote camera; changing a direction of the remote camera; changing a degree of zoom of the remote camera; and changing a crop position of an image that has a wider field of view than is being displayed on the display screen as visual content.

This can be implemented by the controller sending a control signal to the receiving computer; or by the controller performing image processing on images that are acquired by the remote camera. Such image processing can be performed at the remote computer (where the images are acquired) or by a local computer (where the acquired images are received as part of a video feed). Such a control signal can be for adjusting a degree of zoom of the remote camera (for instance to zoom in on the area that corresponds to the recognised eye movement). Alternatively, the control signal can be for causing the remote camera to be redirected (e.g. pan left or right) such that the area that corresponds to the recognised eye movement is positioned closer to the centre of the visual content 862 that is displayed to the user.

Many of the examples disclosed above can advantageously increase the degree of social interaction that can be achieved during a video call, and thereby improve the ability of one or more parties in the video call to communicate with others.

Multiple Users

Returning to FIG. 1, the system 100 may also operate to protect the privacy of onlookers detected in the video of any user. If an onlooker is detected by the camera 106, the system 100 may automatically act to prevent this onlooker being identified or identifiable. In some embodiments, the system 100 may utilise facial recognition in order to determine if a person appearing in the video is the user or an onlooker for whom privacy protection is required or desirable. Facial identification may compare the potential onlooker's face to a database of faces in order to determine a status of the onlooker. The database may include information regarding whose faces are acceptable to transmit and/or whose faces are unacceptable to transmit over the video conferencing system 100. As an example, the system 100 may be configured to allow the continued broadcast of an onlooker identified as a co-worker of the user but may blur the transmitted image, part of the transmitted image such as the face of the onlooker, or cease transmission entirely if the face of a child is detected.

Onlooker Attention

The detection of onlookers may be adapted based on whether or not the onlooker is paying attention to the computer 101. For example, the response of the video conferencing system 100 may be different depending on whether the onlooker is simply present in the background of the transmitted image, for example working at another computer, or whether the onlooker is actively looking at or paying attention to the computer 101 in question.

In some situations, it may be desirable to allow the transmission of the image of the onlooker if they are a collaborator with the user, even if they are only present in the background of the image. Thus, a collaborator in the background, who is looking at the computer 101, may be shown in the transmitted image, whilst a passer-by who is not paying attention to the computer 101 may be blurred to protect their privacy.

Conversely, it may be desirable to blur the face of an onlooker whose attention is on the computer 101 as otherwise their face would be visible to other users of the video conferencing system 100, whilst no blurring of a passer-by may be necessary as their face is not visible due to their lack of attention.

Sharing Information and Multiple Users (Including Onlooker Attention)

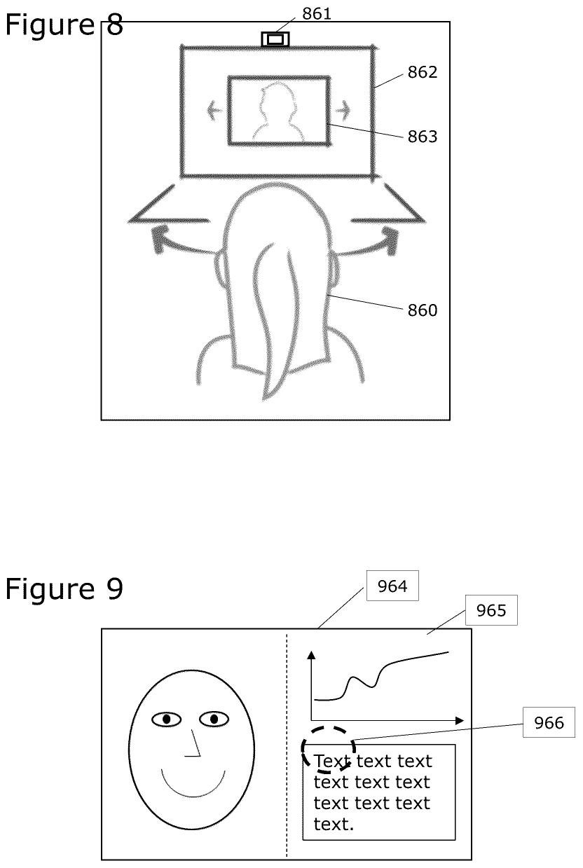

FIG. 9 shows a screen shot of visual content that can be displayed to a user on a display screen 964, and that will be used to describe how a controller of a video conferencing system can generate a data stream that includes a representation of the region of the visual content that the user is looking at. This can include generating a video stream that includes a graphical representation of the region of the visual content that the user is looking at. As shown in FIG. 9, the display screen 964 is displaying: a video feed of a remote user on the left-hand side of the screen 964; and a shared screen 965 (that both the local user and the remote user can see) on the right-hand side. The shared screen 965 is an example of shared visual content that is also displayed to one or more remote users.

The video conference system that is relevant to the screen shot of FIG. 9 includes: a controller, an optional a camera for acquiring images; an eye tracking system providing a gaze-signal; a display screen 964 for displaying visual content to the user; and optionally a transmission system for transmitting a video stream to a receiving computer, wherein the video stream comprises a video stream.

The controller is configured to determine a region of the visual content that the user is looking at based on the gaze-signal. Such processing is well-known in the art. The controller can then generate a data stream (which is not necessarily a video stream) such that it includes a representation of the region of the visual content that the user is looking at. For example, the data stream can include an identifier of the region of the visual content that the user is looking at in such a way that the receiving computer can identify the visual content to which it applies. For instance, the identifier may be a set of coordinates that represent a position on the display screen, and since the receiving computer knows what is being displayed on the user's display screen, it can identify the visual content that the user is looking at. In some implementations, the controller can then pass this information on, in any suitable way, to an operator of the system such as a person who is presenting the shared content.

In another example, the controller can generate a video stream wherein the visual content that the user is looking at has a region of modified content in order to provide a graphical representation of the region of the visual content that the user is looking at. In this way, the controller can generate the video stream such that it includes at least some of the visual content that is being displayed to the user (i.e. the shared screen). In the example of FIG. 9, if the user is reading the first word in the text block, then the outgoing video stream can include an indicator 966 (as an example of a graphical representation) that identifies to the remote user where the user is looking. Optionally, the indicator 966 that represents where the user is looking can also be displayed on the user's local display screen 964 so that they see the same shared screen as the remote user.

In one example, the controller can modify the colour of the region of the visual content that the user is looking at in order to provide the graphical representation. For example, an area of semi-transparent shading can be provided in the region of the visual content that the user is looking at.

The above functionality can be extended to systems that have multiple users with eye tracking capability, such that the gaze-signals from multiple users can be combined. For instance, the controller can receive one or more remote-gaze-signals, which represent the direction of the gaze of one or more remote users that are viewing the shared content. This can be in addition to the gaze-signal that represents the direction of the local user's gaze. The controller can then determine regions of the shared visual content that each of the user and the remote users are looking at based on the respective gaze-signal and the remote-gaze-signals. This can be performed by the controller combining the gaze-signal and the remote-gaze-signals in any suitable way, such as by taking an arithmetic mean of the signals. Then, the controller can generate a video stream such that it includes at least some of the shared visual content that is being displayed to the users (e.g. via screen sharing) and also a graphical representation of the region of the visual content that at least one of the user and the remote users are looking at. The controller can apply the graphical representation to the visual content as a post-processing operation by adding it to a recording of a video conference call, or by adding the graphical representation in near real-time accepting that there may be a slight delay in updating the location of the graphical representation as the various user change their gaze direction. Nonetheless, such a system would still reliably identify regions that draw a user's attention for a reasonable period of time.

In some examples the controller can receive a user-selection-signal that identifies one or more of the user and remote users as selected users. For instance a presenter of the shared content can select one or more of viewers of the shared content that they are interested in. The controller can then generate the video stream such that it includes a graphical representation of the region of the visual content that the selected users are looking at. That is, the presenter can select which of the viewer's gazes they want shown on their screen.

In a further example, a controller can generate a data stream (not necessarily video stream) that includes a representation of the region of visual content that the user is looking at, but the visual content is not necessarily shared content. In such an example, the video conferencing system can include: an eye tracking system; and a display screen for displaying visual content to the user. The controller can determine a region of the visual content that the user is looking at based on the gaze-signal in the same way as described above. In this example, the controller can then determine an identifier of visual content that is being displayed in the region of the display screen that the user is looking at; and if the determined identifier represents an incoming video stream from a remote user that includes an image of a remote user, then generate a data stream (not necessarily video stream) such that it includes an identifier of the remote user. In this way, data can be gathered about who the user (and optionally a plurality of users) are looking at during a video call. This can be especially useful in online learning applications where a teacher can monitor which of the pupils are looking at the video stream of the teacher while they are teaching.

As an optional additional feature, a central controller (which may me centrally located on a server or co-located with one of the users) can receive a plurality of determined identifiers for a plurality of respective users; and combine the plurality of determined identifiers in order to provide a consolidated-feedback-signal. For instance, such a consolidated-feedback-signal may comprise a count of the total number of users that are viewing the incoming video stream.

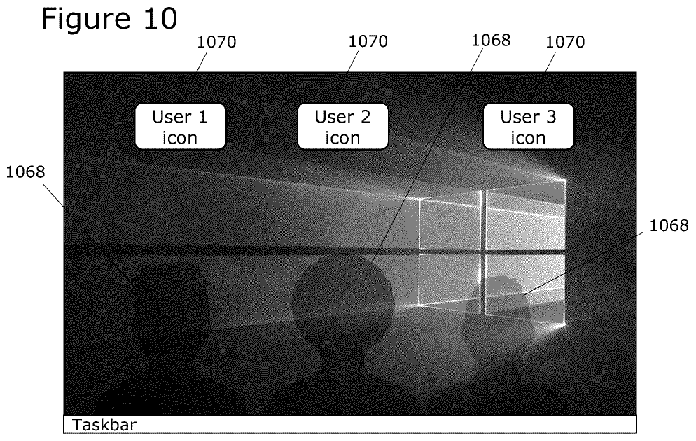

FIG. 10 shows an example of a user's screen that shows how visual representations of a status-stimulus of users of a computing system can be shared between users.

The computing system of this example includes: a camera for acquiring images of the user; and a controller. The computing system may also optionally include an eye tracking system. The controller can recognise a status-stimulus by determining a status of a user in an acquired image. The status-stimulus can comprise one or more of a looking-stimulus, a not-looking-stimulus, a present-stimulus and an absent-stimulus, as non-limiting examples. Further discussion of how such status-stimuli can be determined is provided above with reference to FIGS. 4, 5A, 5B and 5C in particular. In this example, the controller can provide a visual representation of the status-stimulus to other users of the communications system. The visual representation of the stimulus can comprise one or more visual characteristics that are set based on the recognised status-stimulus. In this way, users can readily determine the status/presence of other users based on the visual representation of the other users (as determined by processing acquired images of the other users). Therefore, advantageously the other users don't have to manually set their status for it to be shared.

The user's screen of FIG. 10 shows a first example of visual representations of three remote users that are implemented as silhouettes 1068. A visual characteristic of the silhouettes (such as the darkness of the silhouettes, the presence/absence of the silhouettes, or a head pose of the silhouettes) can be set by the controller based on the recognised status-stimulus. In the example of FIG. 10, the visual representations (here the silhouettes 1068) can be associated with a desktop of the screen such that they are always available in the background. This can provide the user with a convenient way of checking the status of one or more collaborators (such as colleagues that work in the same team) in an intuitive way such that the user can determine whether or not, and how, to communicate with those users based on the visual representation of their statuses.

The user's screen of FIG. 10 also shows a second example of visual representations of three remote users that are implemented as icons 1070. A visual characteristic of the icons (such as the colour of the icons, a darkness of the icons, whether or not the icons are shown ghosted, or the presence/absence of the icons) can be set by the controller based on the recognised status-stimulus. In the example of FIG. 10, the visual representations (here the icons 1070) can be configured such that they are always visible on top of any applications that the user is running. This is another way of providing the user with a convenient way of checking the status of one or more collaborators in an intuitive way.

Furthermore, in some examples the controller can determine a head position of the user by processing the acquired image, and provide a visual representation of the user with the determined head pose. This can provide further context to the user's status, for example by enabling a remote user to recognise that the user is looking at the screen, is present but looking away, has their head down reading a book, etc.

In the example of FIG. 10 a plurality of visual representations of a plurality of users are displayed at the same time. The functionality that is described above can be performed for the plurality of users by a central controller. The central controller may be provided remotely from the users, such as on a server. Alternatively, a controller that is local to one of the users may receive data from each of the users in order to the functionality of a central controller. The central controller can receive a plurality of visual representations of the status-stimuli of a plurality of respective users of the communications system; and present the plurality of visual representations to users of the communications system. This presentation can be as a single consolidated display, such as a line-up of silhouettes 1068 or a collection of icons 1070 as shown in FIG. 10.

In another example of this disclosure, the controller of a video conference system can recognise more than one user in an acquired image. When there is more than one user in the field of view (FOV) of a camera, in some scenarios it can be preferred to not show anybody else other than the primary user in the video call (e.g. if a child appears in the camera feed then it may be preferred not to broadcast images of the child). Whereas in other cases it may be preferred to show the person in the background (e.g. if it is a co-worker). Using a software solution that relies on detecting foreground and background portions of an image may not be capable of providing this functionality, especially when more than one person wants to be visible in the video stream.

The following example presents a user configurable privacy preserving camera and bandwidth optimising video conferencing/video streaming system. The controller can perform the following functionality:
process the image acquired by the camera to determine if a second person is detected in the image. The second person may be assumed to be an onlooker, for instance if a user-configurable setting has been given a value that indicates that only a single person should be present in the video stream. The controller can distinguish between the user (primary person) and the second person using one or more of the following criteria: the person that is furthest from the centre of the image (in either a vertical and/or a horizontal dimension) can be identified as the second person, and the person that is furthest away from the camera (for example the person with the smallest head in the acquired image) can be identified as the second person.
in response to detecting a second person, manipulate the visual representation of the second person in the video stream. For instance, the controller can automatically blur the face of the second person, blur the full frame of the video stream, or stop the video feed to protect the privacy of the second person/onlooker.

In some implementations the controller can determine whether or not to protect the privacy of the second person by manipulating the visual representation of the second person in the video feed based on a facial identification of the second person. For example, the controller may determine whether the second person is in a predefined list of “protected” faces. Such a list can be accessible from computer memory, and can consist of a digital signature of people's faces that can be used to identify a person in an acquired image. For example, a user can register their children's faces in the list such that when they are recognised in an acquired image the visual representation of the child may be manipulated in the video stream. This may be irrespective of whether they are identified as a second person or a primary person in the acquired image. Alternatively, a user can register their co-worker's faces in a list of permitted people such that when the registered co-worker is recognised in an acquired image their visual representation in the video stream is not manipulated, even if they are identified as a second person.

In some implementations, the controller can determine whether or not to manipulate the visual representation of the second person (e.g. to blur the face of the second person) in the video stream based on whether or not the second person is looking at the display screen/camera. The controller can make such a determination by recognising a looking-stimulus or a non-looking-stimulus for the second person in the same way that is described above. In this way, a passer-by can be blurred out because they are not looking at the screen, but a collaborator may be visible in the video stream if they are looking at the screen even if they are in the background.

In another, similar, example, a controller for a video processing system can receive acquired images (either directly from a local camera or from a remote camera associated with a remote computer), and recognise a person in the acquired images in order to determine an identifier associated with the recognised person. If the determined identifier is on a list of protected-identifiers (such as may be associated with children or other vulnerable people), then the controller can generate a video stream based on the acquired images by manipulating the visual representation of the recognised person in the acquired images. Thereby automatically obscuring the identity of the protected person in the video stream. Alternatively or additionally, if the determined identifier is on a list of permitted-identifiers, then the controller can generate a video stream based on the acquired images without manipulating the visual representation of the recognised person in the acquired images. In this way, any people that have been already given their permission to be included in a video stream (such as a co-worker) can be automatically shown on the video feed without being obscured. The processing of this example does not require the identified person to be a “second person” in order for, potentially, their identity to be obscured or revealed in the video stream.

In a yet further, similar, example, a controller for a video processing system can receive acquired images (either directly from a local camera or from a remote camera associated with a remote computer), and identify a person in the acquired images. The controller can then run an age-estimation algorithm on the identified person to provide an estimated-age-value, which represents the estimated age of the identified person. Such age-estimation algorithms are known in the art and can use machine learning, support vector machine (SVM) processing or multi-label sorting, as non-limiting examples. If the estimated-age-value is less than a threshold (such as 10, 16, 18 or 21 in order to identify a child or young person), then the controller can generate a video stream based on the acquired images by manipulating the visual representation of the identified person in the acquired images. Thereby automatically obscuring the features of the identified person in the video stream. Alternatively or additionally, if the estimated-age-value is greater than a threshold, then the controller can generate a video stream based on the acquired images without manipulating the visual representation of the identified person in the acquired images. In this way, any people that are younger than a threshold age can be automatically obscured in the video feed.

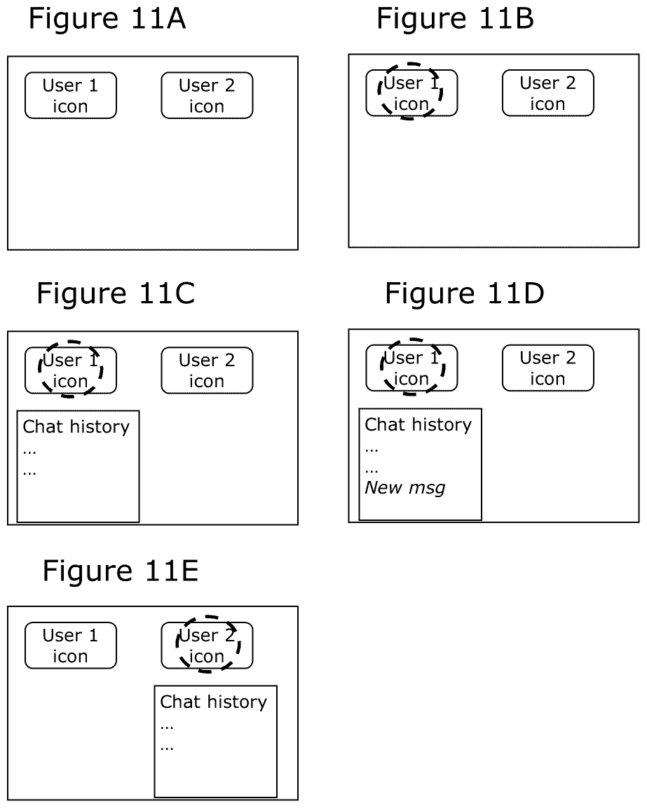

FIGS. 11A to 11E show a sequence of five screenshots that will be used to describe a method of facilitate a communication exchange between the user and another user.

This example relates to a communications system (such as a messaging/chat system or a voice/video communications system). The communications system includes: a camera for acquiring images; an eye tracking system for providing a gaze-signal that represents the direction of the user's gaze; a display screen for displaying visual content to the user, including one or more representations of other users of the communications system; and optionally a microphone for acquiring audio data (for examples where the communications system provides for voice/video communication).

The communications system also includes a controller that can determine a region of the display screen that the user is looking at based on the gaze-signal. This can be achieved in any way known in the art, and as described elsewhere in this document. The controller can then identify one of the other users of the communications system that is associated with determined region of the display screen that the user is looking at as a selected-other-user. Then, in response to identifying the selected-other-user, the controller can facilitate a communication exchange between the user and the selected-other-user. For a voice or video communications system this can involve initiating a call to the selected-other-user. For a chat/messaging communications system this can involve opening up a chat history/text entry box so that the user can directly type a message to the selected-other-user. In this way, the controller facilitates the communication exchange between the user and the selected-other-user by inserting text into a chat message with the selected-other-user based on subsequently received keystrokes, without the user having to manually select the selected-other-user to start chatting.

FIG. 11A shows an example of a user's screen that shows two icons, one icon for User 1 and another icon for User 2. FIG. 11B shows schematically that the user's gaze-signal has been processed and the controller has determined that the user is looking at the icon for User 1.

In response to recognising that the user is looking at User 1 icon, the controller opens up a chat history with User 1, as shown in FIG. 11C. The user can now start typing, without having manually selecting or opening up the chat history with User 1, directly into a new chat message with User 1. This is shown in FIG. 11D. In this way, the controller can put the focus on a new message in the chat history with User 1 in response to the user simply looking at the icon for User 1.

Then, if the user redirects their gaze to the icon for User 2, as shown schematically in FIG. 11E, the controller closes the chat history for User 1 and opens the chat history for User 2. Then any subsequently received keystrokes are associated with typing a new message to User 2.

In some examples, the controller can facilitate/initiate the communication exchange between the user and the selected-other-user while the controller determines that the user is looking at the selected-other-user. If the controller determines that the user is no longer looking at the selected-other-user, then the controller can end the communication exchange. For example by removing the focus from a chat history or closing the chat history, or by ending a voice/video call. In some examples, the controller may only end the communication exchange after a minimum period of time since the last communication has expired. In this way, if the communication exchange is still ongoing but the user looks away from the selected-other-user, the communication exchange is not immediately terminated.

In examples where the communications system can receive voice or video calls, the controller can initiate the communication exchange between the user and the selected-other-user by transferring subsequently acquired audio data to the selected-other-user. The controller can transfer the subsequently acquired audio data to the selected-other-user in real-time as part of a “live” video or audio call. Alternatively, the controller can convert the audio data to text and then transmit the text to the selected-other-user. As a further alternative, the controller can: record the subsequently acquired audio data to the selected-other-user; convert the recorded audio data to text; and transmit the text to the selected-other-user.

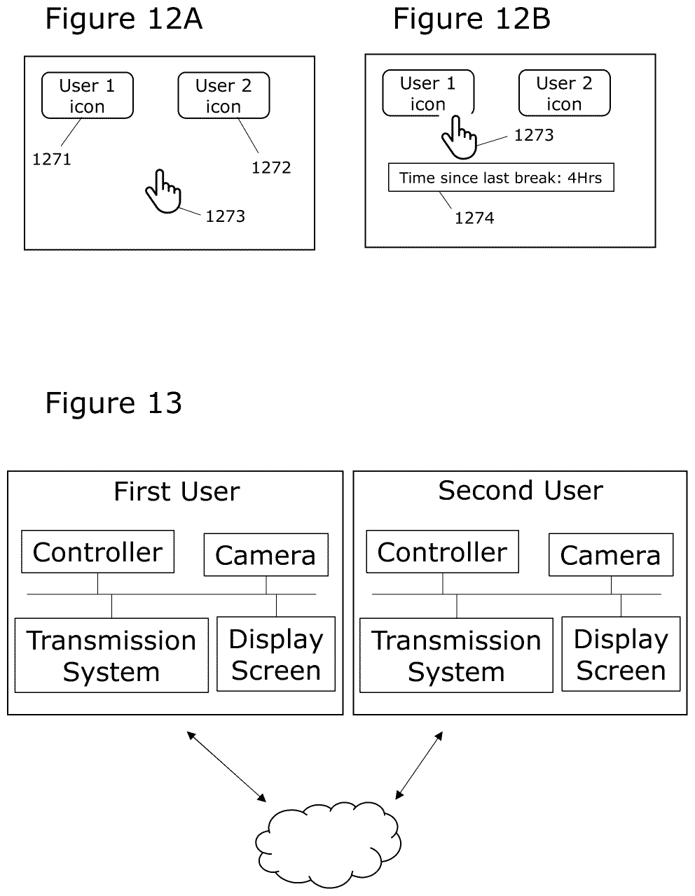

FIGS. 12A and 12B show a sequence of two screenshots that will be used to describe a method of transmitting information about a user's activity to other users of a computing system.

Such an example can relate to a computing system that includes a sensor for providing sensor-signalling that represents one or more characteristics of a user that affect their wellbeing. The sensor for providing the sensor-signalling can include one or more of: a camera, an eye tracking system, a microphone, a time of flight sensor, radar, ultrasound, or any other suitable sensor that is known in the art.

The computing system can include a controller for determining a wellbeing status of the user based on the sensor-signalling. Various wellbeing statuses are known in the art, and include one or more of: user attentiveness (such as, but not necessarily, attentiveness to a region on the screen), eye openness patterns, time since last break, drowsiness (based on blinks, eye openness), emotional state, position or orientation of the user's head in an acquired image), various different gaze metrics. Furthermore, the controller can determine the wellbeing status by aggregating the sensor-signalling, or information derived from the sensor-signalling (such as intermediate wellbeing/mood/emotional states), over a period of time. In this way, the wellbeing status of the user is not necessarily determined by an instantaneous state of the sensor-signalling, but can be considered as a level of wellbeing aggregated over time by any of the above stimuli of the user based on the sensor-signalling.

The controller can then transmit a representation of the wellbeing status to other users of the computing system. In this way, the other users can take action to assist the user improve their mood/wellbeing. Examples of how such representations can be shared are described below in relation to the specific wellbeing status.

In some examples, the controller can determine a (non-binary) wellbeing score for the user based on the sensor-signalling. For instance, a score on a scale of 1 to 10. The controller can then generate a graphical representation of the wellbeing status/wellbeing score, and transmit the graphical representation to other users of the computing system.

In another example, the controller can generate a video stream based on acquired images of the user (for example as part of a videoconferencing call) and also based on the graphical representation. In such cases, the graphical representation can be an illustration of a health/wellbeing bar that is filled up according to the determined wellbeing status/wellbeing score.

In a yet further example, the controller can generate a video stream based on acquired images of the user that includes meta-data that represents the wellbeing status/wellbeing score.

In one example, the sensor is a camera and sensor-signalling represents acquired images. In such an example, the controller can process the acquired images in order to identify a user taking a break. In one example, the controller can identify a user taking a break by: recognising a present-stimulus by determining that a user is visible in an acquired image (as discussed above); recognising an absent-stimulus by determining that a user is not visible in an acquired image (again, as discussed above); and then identifying a break if the controller determines an absent-stimulus for at least a predetermined period of time. Use of such a predetermined period of time can be useful for reducing the likelihood that any temporary absence of the user from their video feed, such as may occur if they pick something up from the floor and duck out of the field of view of the camera, is incorrectly identified as a break.

The controller can then cause times associated with identified breaks to be recorded in memory, and transmit a representation of the recorded times of the identified breaks to other users of the computing system. Such a transmission of the recorded times can be performed in a number of different ways, as discussed below.

In one example, the controller can determine how long the user has been at their computer since their last break as an active-duration; and transmit the active-duration to other users of the computing system. The controller can transmit the active-duration to one of the other users of the computing system in response to a request from the other user. The request can involve the other user putting a focus on the user (e.g. by moving their cursor over an icon that represents the user). This is shown schematically by FIGS. 12A and 12B. In FIG. 12A icons for two other users 1271, 1272 are shown on the user's display. The user's cursor 1273 is not over either of the two other user icons 1271, 1272 in FIG. 12A. In FIG. 12B, the user has moved the cursor 1273 such that is over (or otherwise associated with) the icon for User 1 1271. In response, the controller for the user makes a request to a controller associated with User 1 (which may a controller that is local to User 1 or a central controller) for the active-duration of User 1. The controller for the user then receives data that indicates that the active-duration for User 1 is 4 hours and displays this information to the user by way of a pop-up 1274.

In another example, the controller can determine how long the user has been at their computer since their last break as an active-duration; and set a visual characteristic of an icon that represents the user to the other users based on the determined active-duration. In this way, the active-duration (or a representation of it) can be pushed to other users. For instance, the controller can set the colour of a component of the icon that represents the user to the other users based on the determined active-duration. In one implementation, if the determined active-duration is greater than one or more threshold values, then the controller can change the colour to indicate a greater severity of the length of time that the user has gone without a break. This can beneficially raise concerns with the other users and therefore assist with the user's mental health and wellbeing.

This can address a challenge of working remotely (especially during a pandemic), in that users may tend to spend all day in front of their computer without taking a break. This concept emphasizes the social aspects of digital wellbeing by sharing digital wellbeing statistics to friends and colleagues (e.g. time since last break) such that the friends and colleagues can encourage the user to take a break.

In some examples, the controller can determine how long the user has been at their computer (e.g. active/present/looking, all as discussed above) since their last break as an active-duration. If the active-duration is greater than a threshold, then the controller can automatically generate an alert for the user, with the intention of encouraging them to take a break. Additionally or alternatively, if the active-duration is greater than a threshold, then the controller can automatically generate an alert for the other users, with the intention of the other users encouraging the user to take a break.

As an extension to one or more of the above concepts, a central controller (which may be a controller that is associated with an individual user or one that is remote from all of the users) is configured to receive details of the recorded times of the identified breaks of a plurality of users. The central controller can then combine the details of the recorded times of the identified breaks of the plurality of users to provide combined-break-details, and transmit a representation of the combined-break-details to other users of the computing system. The principles here are very similar to those described above with respect to individual users.

FIG. 13 shows an example of a computing system, which is usable for a plurality of users to watch the same video content, in some examples simultaneously. Typically such users are in separate locations.

The computing system includes a first camera for acquiring first images of a first user watching video content on a first display screen, and a second camera for acquiring second images of a second user watching the same video content on a second display.

The computing system also includes one or more controllers. In FIG. 13 a separate controller is shown associated with each user, although it will be appreciated that some or all of the functionality of the controllers that is described herein may be provided by local controllers or by a central controller (not shown).

The controller can recognise a first-stimulus in one or more images acquired by the first camera, and identifying a corresponding first portion of the video content that was being displayed to the first user. The controller can also recognise a second-stimulus in one or more images acquired by the second camera, and identify a corresponding second portion of the video content that was being displayed to the second user. As will be appreciated from the description that follows, any stimuli that are disclosed in this document or are known in the art can be recognised.

For instance, the first-stimulus and/or the second-stimulus comprise one or more of: an emotional-stimulus; a gesture-stimulus; a looking-stimulus or not-looking-stimulus; a status-stimulus; and a present-stimulus or an absent-stimulus. Each of which are described in detail above.

Additionally or alternatively, a stimulus can be, or can be derived from, a determination of whether the user paid attention, or did not pay attention, the recognition of which is known in the art. As further examples, the stimulus can represent drowsiness, eye openness, etc.

Of course, a plurality of (perhaps very many) such portions may be identified for a given piece of video content. The plurality of portions do not need to be contiguous clips in the video content.

The controller can then identify portions of the video content that have been identified as both a first portion and a second portion as highlight-portions, and provide an output-video based on the highlight-portions.

The generation of video content in this way can further improve the social benefits in consuming shared video content and can represent a new way of generating video content.

In some examples, the first-emotional-stimulus is the same as the second-emotional-stimulus. That is, a highlight-portion is determined if both users have the same emotional response to the same portion of the video content (e.g. both users are laughing).

In some examples, the first-emotional-stimulus is different to the second-emotional-stimulus. That is, a highlight-portion is determined if the users have a different emotional response to the same portion of the video content (e.g. one user is laughing and the other user is crying).

If the first-stimulus and the second-stimulus are of the same type, then the output-video can comprise an amalgamation of the portions of the video that appealed to both users (as determined by eliciting an emotional response by both the users) as an automatically generated highlights reel, that drew particular attention from both users, or conversely for which both users did not pay attention (in which case the output-video can be useful for informing the users of the portions of the video that they both missed).

In some examples, the computing system can also include an eye tracking system that can be used to identify also be that one or many users “paid attention” to the same snippet of the video, and optionally that they “paid attention” to the same region of the screen”.

It will be appreciated that the above functionality can be extended to a system that has more than two users. In which case the controller can identify the highlights-portions in a number of different ways. For instance, if an emotional-stimulus is recognised for a minimum number of users; which may be an absolute minimum number such as at least 100 users, or a minimum proportion of the users such as at least 50% of the users.

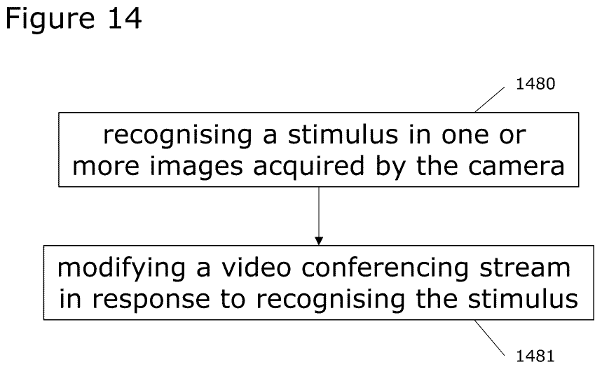

FIG. 14 shows schematically a computer implemented method of operating a video conferencing system according to the present disclosure.

As discussed above, the video conferencing system includes: a camera for acquiring images; and a transmission system for transmitting a video stream to a receiving computer.

At step 1480, the method involves recognising a stimulus in one or more images acquired by the camera. A variety of examples of stimuli are described in detail above.

At step 1481, the method involves modifying/generating a video stream in response to recognising the stimulus.

It will be appreciated that there are multiple ways that various ones of the systems described herein can be implemented. For example, the logic for providing the described functionality can be applied at the application layer (e.g. the video conferencing application) or it can implemented as a virtual camera system that can then be used by any applications without changes to the application system.

Examples disclosed herein pertain to both implementations.

1-66. (canceled)

67. A controller for a computing system, wherein the computing system includes a sensor for providing sensor-signalling that represents one or more characteristics of a user that affect their wellbeing, and wherein the controller is configured to:
determine a wellbeing status of the user based on the sensor-signalling;
transmit a representation of the wellbeing status to other users of the computing system.

68. The controller of claim 67, further configured to determine the wellbeing status by aggregating the sensor-signalling, or information derived from the sensor-signalling, over a period of time.

69. The controller of claim 67, wherein:
the sensor for providing the sensor-signalling comprises one or more of: a camera, an eye tracking system, a microphone, a time of flight sensor, radar, and ultrasound; and/or
the wellbeing status represents one or more of: user attentiveness, eye openness patterns, time since last break, screen time vs break time, emotional state, various different gaze metrics.

70. The controller of claim 67, wherein the controller is configured to:
determine a non-binary wellbeing score for the user based on the sensor-signalling; and
transmit a representation of the wellbeing score to the other users of the computing system.

71. The controller of claim 70, wherein the controller is configured to:
generate a graphical representation of the wellbeing score; and
transmit the graphical representation to other users of the computing system.

72. The controller of claim 71, wherein the controller is configured to:
generate a video stream based on acquired images of the user and also based on the graphical representation.

73. The controller of claim 70, wherein the controller is configured to:
generate a video stream based on acquired images of the user that includes meta-data that represents the wellbeing score.

74. The controller of claim 67, wherein:
the sensor is a camera and the sensor-signalling represents acquired images; and
the controller is configured to:
process the acquired images in order to identify a user taking a break;
cause times associated with identified breaks to be recorded in memory; and
transmit a representation of the recorded times of the identified breaks to other users of the computing system.

75. The controller of claim 74, wherein the controller is configured to:
determine how long the user has been at their computer since their last break as an active-duration; and
transmit the active-duration to other users of the computing system.

76. The controller of claim 75, wherein the controller is configured to transmit the active-duration to one of the other users of the computing system in response to a request from the other user.

77. The controller of claim 76, wherein the request comprises the other user positioning a cursor over an icon that represents the user.

78. The controller of claim 67, wherein the controller is configured to:
determine how long the user has been at their computer since their last break as an active-duration; and
set a visual characteristic of an icon that represents the user to the other users based on the determined active-duration.

79. The controller of claim 78, wherein the controller is configured to set the colour of a component of the icon that represents the user to the other users based on the determined active-duration.

80. The controller of claim 67, wherein the controller is configured to:
determine how long the user has been at their computer since their last break as an active-duration; and
if the active-duration is greater than a threshold, then automatically generate an alert for the user.

81. The controller of claim 67, wherein the controller is configured to:
determine how long the user has been at their computer since their last break as an active-duration; and
if the active-duration is greater than a threshold, then automatically generate an alert for the other users.

82. The controller of claim 67, wherein the controller is configured to process the acquired images in order to identify a user taking a break by:
recognising a present-stimulus by determining that a user is visible in an acquired image;
recognising an absent-stimulus by determining that a user is not visible in an acquired image; and
identifying a break if the controller determines an absent-stimulus for at least a predetermined period of time; and
generate a video stream based on the acquired images, and set a characteristic of the video stream based on the absent-stimulus by automatically creating, and providing as the video stream, a looping video of historic video stream data during which the absent-stimulus was not recognised.

83. The controller of claim 67, further comprising the functionality of a central controller that is configured to:
receive details of the recorded times of the identified breaks of a plurality of users;
combine the details of the recorded times of the identified breaks of the plurality of users to provide combined-break-details; and
transmit a representation of the combined-break-details to other users of the computing system.

84. A computing system comprising the controller of claim 67.

85. A computer-implemented method of operating a computing system, the method comprising:
determining a wellbeing status of the user based on the sensor-signalling; and
transmitting a representation of the wellbeing status to other users of the computing system.

86-97. (canceled)
